(19) United States
(12) Patent Application Publication
(10) Pub. No.: US 2010/0316983 A1
(43) Pub. Date: Dec. 16, 2010

(54) EDUCATIONAL EXERCISE SYSTEM AND METHOD SIMULATION OF SWORDPLAY

(76) Inventor: William Burgan Johns, JR., Sammammish, WA (US)

Correspondence Address: BLACK LOWE & GRAHAM, PLLC, 701 FIFTH AVENUE, SUITE 4800, SEATTLE, WA, 98104, US

(21) Appl. No.: 12/813,449

(22) Filed: Jun. 10, 2010

Related U.S. Application Data
(60) Provisional application No. 61/185,937, filed on Jun. 10, 2009.

(51) Int. Cl. G09B 19/00; A63B 69/02

(52) U.S. Cl. 434/247; 482/12

(57) ABSTRACT

Provided herein is a role-playing sword-playing fitness-oriented educational system and method with physical game devices, as well as rules for their use. Players assume the roles of imaginary characters in a fictitious storyline and use sword devices and set value oriented tasks to progress through the game and achieve rewards and higher ranking as recognized in the domains of physical combat, magical forces, and technological abilities. The system and method integrates a fitness program, fantasy role-playing game, and martial arts into a personal development program for kids. Game apparatus are interactive padded swords that require physical interaction between players wherein through the demonstration of strategic and technological skills as well as achievement of value based skills the player achieve higher rankings and rewards.

### CROSS-REFERENCE TO RELATED APPLICATIONS

This application claims priority to U.S. Provisional Application Ser. No. 61/185,937 filed Jun. 10, 2009 which is incorporated herein by reference.

### COPYRIGHT NOTICE

This disclosure is protected under United States and International Copyright Laws. © 2006-2010 William Burgan Johns, Jr. All Rights Reserved. A portion of the disclosure of this patent document contains material which is subject to copyright protection. The copyright owner has no objection to the facsimile reproduction by anyone of the patent document or the patent disclosure after formal publication by the USPTO, as it appears in the Patent and Trademark Office patent file or records, but otherwise reserves all copyright rights whatsoever.

### FIELD OF THE INVENTION

This invention relates generally to youth education, fitness & personal development/behavior modification and, more specifically, simulation and incorporation of popular fantasy media elements to an organized fitness and exercise regime and game format to increase the fitness of kids everywhere and to provide them with a non-religious spiritual education and increased self-esteem.

### BACKGROUND OF THE INVENTION

A recent study found only 10% of school age children had the physical activity they needed for cardiovascular health.

Sedentary lifestyles may be partly to blame. Twenty years ago children walked to school. Today, parents drive their children to school even if they live only a few blocks away. A generation ago, students got home from school and ran outside to see where their friends were. Today, they run to their computers or iPods® and see who is on MSN® or MySpace®. In the past, television had only a few channels and if nothing was of interest, kids chose to go outside. Today, they have over 100 channels to choose from and are likely to find something to watch instead of getting fresh air and exercise. And, more and more education is being offered over the computer through virtual high schools.

In school, students had more time to get outside for recess and participate in P.E. Today, more and more time is being cut from physical activity to make time for academics. No Child Left Behind in the U.S. is demanding growth in math and reading to the extent that schools must find more time to teach. P.E. and recess are often areas to be cut to add teaching time.

The problem of childhood obesity in the United States has grown considerably in recent years. Over the past three decades, the childhood obesity rate has more than doubled for preschool children aged 2-5 years and adolescents aged 12-19 years, and it has more than tripled for children aged 6-11 years. At present, approximately nine million children over 6 years of age are considered obese, that is, between 16 and 33 percent of children and adolescents are obese.

Obesity is among the easiest medical conditions to recognize but most difficult to treat. Unhealthy weight gain due to poor diet and lack of exercise is responsible for over 300,000 deaths each year. The annual cost to society for obesity is estimated at nearly $100 billion. Overweight children are much more likely to become overweight adults unless they adopt and maintain healthier patterns of eating and exercise.

Even more alarming, young people are at risk of developing serious psychosocial burdens related to being obese in a society that stigmatizes this condition, often fostering shame, self-blame, and low self-esteem that may impair academic and social functioning and carry into adulthood.

The health concerns are immediate and warrant urgent preventive actions. Preventing childhood obesity is a collective responsibility requiring individual, family, community, corporate, and governmental commitments. The key will be to implement changes for this issue from many directions and at multiple levels, and through collaboration with and between many sectors. In this context, a need exists to re-engage children in healthy, positive, physical activities in the face of competition of hi-tech gadgetry that is seemingly so much more engaging to a child's imagination.

Sunday school, in one form or another, has been the traditional provider of spiritual education for the children of America. According to the Barna Group, a respected Christian based research firm that has provided static data for The Disney Channel, the American Broadcasting Company, VISA and the military, less that 25% of children attended Sunday School as of 2006.

Research supports a direct correlation between low self-esteem and negative outcomes and high self-esteem and positive outcomes. Some examples are: a direct correlation between high self-esteem and high academic achievement (Covington, 1989); low self-esteem and alcoholism and drug abuse (Candito, 1996); low self-esteem and neurosis, anxiety, defensiveness and ultimately alcohol and drug abuse (Keegan, 1987); low self-esteem and delinquent behavior in juveniles (Keeley, 1978); low self-esteem and increased violence and criminal behavior (Kaplan, 1975); increased self-esteem decreases anti-social behavior, vandalism and incidents of verbal and physical aggression in schools (Reasoner, 1992; Borba, 1999); low self-esteem and depression and suicide in young people (Battle, 1980); and low self-esteem and pregnancy among teenage girls (Hayes and Fors, 1990)

### BRIEF DESCRIPTION OF THE DRAWINGS

Preferred and alternative examples of the present invention are described in detail below with reference to the following drawings:

FIG. 1 is an exemplary SwordFit® SOP (Standard Operating Procedures sheet) in accordance with one embodiment of the invention;

FIG. 2 is an exemplary SwordFit® student participation waiver in accordance with one embodiment of the invention;

FIG. 3 is an exemplary SwordFit® enrollment agreement form in accordance with one embodiment of the invention;

FIG. 4 are exemplary SwordFit® Gear Voucher cards in accordance with one embodiment of the invention;

FIG. 5 is an exemplary SwordFit® PowerSword™ handout in accordance with one embodiment of the invention;

FIG. 6 is an exemplary SwordFit® Levels handout in accordance with one embodiment of the invention;

FIGS. 7A AND 7B are exemplary SwordFit® information cards in accordance with one embodiment of the invention;

FIGS. 8A and 8B are exemplary SwordFit® Administrative Tracking System sheets in accordance with one embodiment of the invention; and

FIGS. 9A and 9B are images of players engaging in a exemplary Swordfit bout in accordance with one embodiment of the invention.

### DESCRIPTION OF EMBODIMENTS

The SwordFit® system and method satisfies a long-standing need in our communities; supplying parents, schools, the government and all concerned parties with a way to battle the fitness problem, lack of spiritual education and low self-esteem that plague today's youth—in a way that won't require any coercion (and thus negativity) from any of these interested parties. The SwordFit® system and method engages children in a fantasy and role-play educational curriculum system and method; engaging children in a way that children naturally enjoy. Moreover the SwordFit® system satisfies the long-standing need that most parents have to educate their children in virtues that prepare them for success in life. Life has become so fast paced and time-consuming that many parents don't have time to proactively impart to their children the spiritual education needed to develop in their children positive traits that will increase their self-esteem and prepare them for success in life. All that most parents manage to do is to react to misbehavior once it arises: MOST PARENTS SIMPLY DON'T HAVE THE TIME OR RESOURCES TO BE PROACTIVE. The SwordFit® system and method is an Encouragement Centered Education™ system designed to builds confidence and self-worth.

In one exemplary embodiment a Swordfit® method teaches sword play and strategy to promote healthy fitness habits and normative values in children comprising by providing a player with a flexible sword device and providing a structured sword-training regime. The structured sword-training regime can have a plurality of set skill levels where each skill level corresponds to a rank. Players engage in sparring bouts against each other and each player may advances from a first primary rank to a successively higher rank based on mastery at each skill level of specific sword-fighting technical challenges. As the rank of the player advances, the player advances to a next training level. The player is awarded a level ring when the player meets requirements of rank advancement, the level ring being displayable on the flexible sword device to indicate the player's advancement from the first primary rank to the successively higher rank. A power ring can be awarded to a player when the player meets requirements of specific sword-fighting technical challenges and missions, where said power rings are representations of respective powers that augment the abilities of the flexible sword device and conferred to the player to be displayed on the flexible sword device to indicate the player's augmented powers assertable over the opponent.

In a preferred embodiment the a Swordfit® method can include providing one or more players with a flexible sword-like device; providing a structured sword-training regime having a plurality of skill levels wherein one or more of each skill level corresponds to a rank and where players engage in sparring bouts and each player may advance from a first rank to a higher rank based on mastery at each skill level; advancing the rank of one or more of the players; and awarding a level ring to the player when the player meets one or more requirements of rank advancement, said level ring being displayable on the flexible sword-like device to indicate the player's advancement from the first rank to the higher rank

In another embodiment Swordfit® can further include awarding a power ring to a player when the player meets one or more requirements of specific sword-like device fighting technical challenges or missions; wherein said power rings represent respective powers that augment the abilities of the flexible sword-like device and are conferred to the player to be displayed on the flexible sword-like device.

In one embodiment SwordFit® is an educational system and method, which integrates a fitness program, fantasy role-playing game, and martial arts into a personal development program for kids. The merger of the various aspects of disparate activities into a synergistic whole that is the SwordFit® system and method, engages a child's imagination and creativity in a game of strategy—while also providing an aerobic fitness program. SwordFit® has an advantage over traditional methods because of its ability to integrate fantasy with the aerobic activity, sword fighting—but in a completely safe, inexpensive, non-violent, and constructive way.

In one embodiment SwordFit® is an entire curriculum structured around music: this keeps an instructor from hijacking a physical activity with a lecture. It also keeps the participants moving. Additionally, in one embodiment music can control when Swording™ takes place and thereby restricts that time to 1 minute intervals: when the music stops the Swording™ stops: this gives participants a chance to cool off both physically and emotionally (emotions can run high when swording—if your partner is hitting too hard, not bowing, etc).

In another embodiment, SwordFit® is a purposeful integration of an entire fantasy construct as a predominant component that is pervasive to the entire SwordFit® class experience: this keeps kids excited about the activity, which keeps them engaged and lets SwordFit® achieve its purposes.

A specific embodiment of SwordFit® links fantasy and a fitness program to a complete behavior modification and spiritual education program that can be leveraged by parents for results at home and in school. In one aspect for example, SwordFit® participants bow whenever they are touched; prevents a participant from overwhelming and traumatizing another participant with multiple strikes, and teaches self-control and self-limiting behavior. In this way, the SwordFit® system and method harnesses what is excellent about martial arts oriented activity and removes many of what are often considered negative aspects of the martial arts. SwordFit® participants learn and engage in a genuine martial skill but in a fantasy game setting where uniforms are unnecessary for the first 2¼ years of training (that can need to be bought, forgotten, get dirty/ruined, changed into while trying to hurry to class) only a hakama (martial arts “skirt”) for the next 4½ years (which easily slips over regular pants enabling it to be changed into in a public setting, since so no disrobing is required) and the addition of a martial arts jacket upon reaching the master level after no less than 7 years of training (the jacket is also easily slips on over any shirt so no disrobing is required); belts (which come untied and fall off during class); rank tests (which usually cost extra and put pressure on kids who are already stressed out with the fast pace of hi-tech life and stress bleeding off parents who are overextended); and no class “dead times” (where participants aren't moving, but instead are standing around watching demonstrations or listening to a teacher talk).

In SwordFit® at one of the following levels:

a) Apprentice Regional Instructor; b) Regional Instructor; c) Master Regional Instructor—each level as per local chapter instructors only with respective regional responsibilities.

b. Regional Administrator(s)

1) A volunteer position.

2) Elected every two years, from among, and by, the chapter administrators; by secret ballot, and without nomination or campaigning.

3) May bulk order SwordFit® student gear for local chapters.

4) Conducts SwordFit® administrator classes for chapter administrators

5) Recommends chapter administrators for the various levels of certification

6) Acts as a consultant for the region's chapter administrators

7) Acts as a liaison to upper echelons of the SwordFit® organization

8) Must be certified by SwordFit® at one of the following levels:

a) Apprentice Regional Administrator; b) Regional Administrator; c) Master Regional Administrator—each level as per local chapter Administrators only with respective regional responsibilities.

3. National personnel

a. National Instructor(s)—(usually one or more Regional Master Instructor(s) from one or more of the regions in the nation): elected every three years, and with responsibilities, as per regional Instructors only with respective national responsibilities.

1) Either a subcontracted or employee position (travel room and board may be paid for).

2) Instruct regional instructors.

b. National Administrator(s)—(usually one or more Master Administrator(s) from one or more of the regions in the nation): elected, and with responsibilities, as per regional Administrators only with respective national responsibilities.

1) Either a subcontracted or employee position.

2) Is responsible for directing both retained earnings at the national level, and retained earnings received from the international level to impoverished local chapters to subsidize local programs for disadvantaged youth.

3) Mentor regional administrators.

4. International personnel

a. Council of Masters (CM)

1) Either a subcontracted or employee position (travel room and board paid for).

2) Instruct National Instructors.

3) Elected every 5 years, as per regional instructors, from the ranks of the National Master Instructors with a limit of 1 CM per nation;

a) Automatically includes, for a lifetime term, as additional CM(s) (not to replace any CMI elected from any nation), the founder of SwordFit®.

b) Automatically includes, for a lifetime term, as additional CM(s) (not to replace any CM elected from any nation), any bloodline relations of the founder of SwordFit® who have achieved the level of a National Instructor (both positions may be held simultaneously).

c) Meets annually for Swording™ training and to approve technical changes (swordplay techniques) in the SwordFit® curriculum by a majority consensus from among the CMs (voting only when a consensus cannot be reached after 9 consultative attempts—with each CM casting one vote; the founder casting one vote; and any bloodline relations of the founder casting one vote for every 5 such relations with a maximum number not to exceed 1/9 of the total number of national elected CMs).

b. Council of Instructors (CI)

1) Volunteer position (travel room & board may be paid for).

2) Elected every 2 years, as per regional instructors, 1 from each nation, from among the members of two different groups:

a) The instructors from each nation who instruct a total number of students per week that puts them in the top 10% of instructors teaching the largest number of students in that nation.

b) As per a) above only for the smallest number of students in that nation.

c. Council of Participants (CP) and their immediate families, appointed by the 2nd place runner up for the CI position in each of the two CI categories above (cannot be blood or legal relation to the runner up).

1) Volunteer position (travel room and board may be paid for).

2) Appointed every 2 years unless the elected participant ceases taking SwordFit® classes, in which case a replacement participant may be appointed following the same guidelines as for the originally appointed participant.

d. Council of Administrators.

1) Volunteer position.

2) Elected every 2 years, as per regional instructors, 1 from each nation.

3) Is responsible for redirecting retained earnings at the international level to impoverished nations, or nations with impoverished regions within them; or directly to local chapters in impoverished nations who have no regional or national SwordFit® administrative structures in place.

4) Meets annually to approve administrative changes in the SwordFit's® Standard Operating Procedures and other administrative concerns by a majority consensus from among the CAs (voting only when a consensus cannot be reached after 9 consultative attempts—with each CA casting one vote; the founder casting one vote; and any bloodline relations of the founder casting one vote for every 5 such relations with a maximum number not to exceed 1/9 of the total number of national elected CAs).

5) Combined International Council (CIC).

1) Composed of the combined members of the CMI, CI, CP and CI as stated above

a) Meets annually to approve non-technical changes to the SwordFit® curriculum (exclusive of any swordplay techniques) using the same consultative guidelines as for the CMI.

b) May only make one non-technical change annually unless, under extreme circumstances of change in the world culture, the CMI approves any number of additional changes.

B. Materials

1. Instructor materials

1) 1 Hakama (martial arts “skirt”) of appropriate color

2) 1 Medium weight, cotton, appropriately colored, traditional, martial arts, uniform jacket

3) 1 Black Ronin helmet

4) 1 Black 40″ Actionflex sword

5) Xplod “Boombox”

6) 8 SwordFit® music CD's

7) 4 L/XL Red Ronin helmets (with “L//XL” marked in black permanent marker on the outside end of rear strap)

8) 4 S/M Red Ronin helmets (with “S/M” marked in black permanent marker on the outside end of rear strap)

9) 5 Red 40″ Actionflex swords (with 4 black, nickel-sized, circles—equally spaced and marked about 1″ from the end of the sword shaft—in black permanent marker)

10) 1 container of antiseptic wipes/towlets

11) 1 roll of silver Duct tape

12) 1 medium tipped, black, permanent marker.

13) 1 medium tipped, red permanent marker

14) 1 student roll book

15) 5 medium point blue stick pens

16) Long, cotton, terry cloth wrist bands of the following colors

17) 1) 20 black; 2) 5 white; 3) 5 red; 4) 5 green; 5) 5 dark green; 6) 5 blue; 7) 5 orange; 8) 5 purple; 9) 5 Fuchsia

18) 10 white and 5 yellow/gold, cotton, terry cloth headbands.

19) 1 pair Pine Tree, light weight, martial arts shoes

20) Digital camera (with video & audio capability) with batteries, memory card(s) and padded carrying case.

21) 3 medium sized black bags—net: come with ronin helmets

22) Zippered, black, hard-covered, file-folder container (available at Staples) containing:

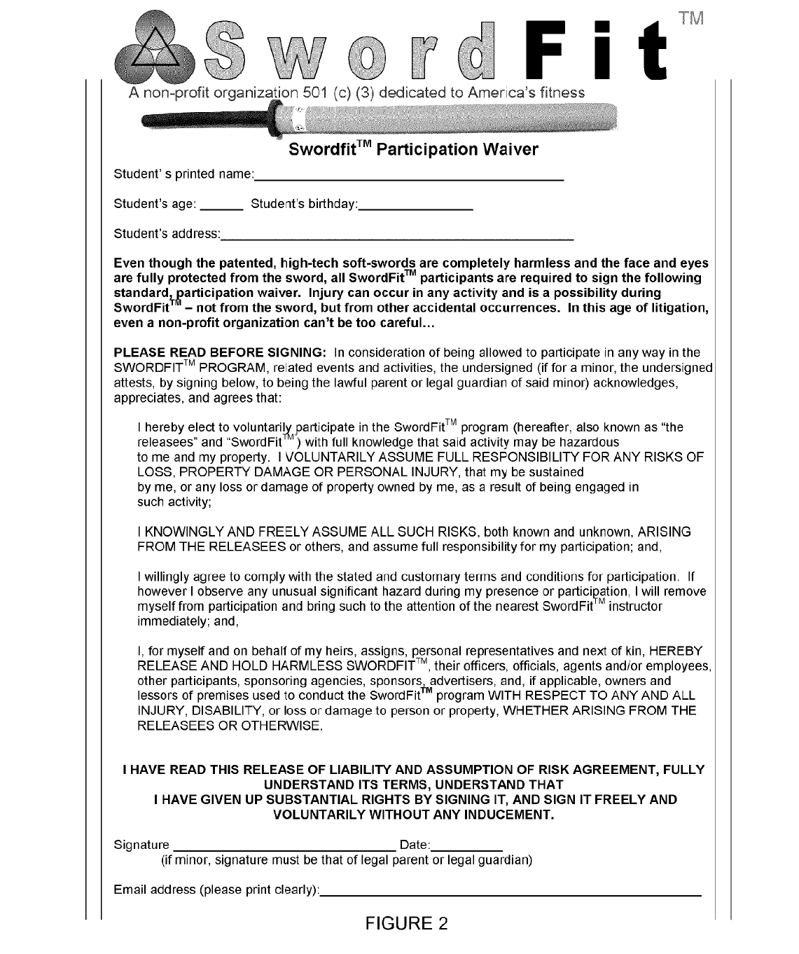

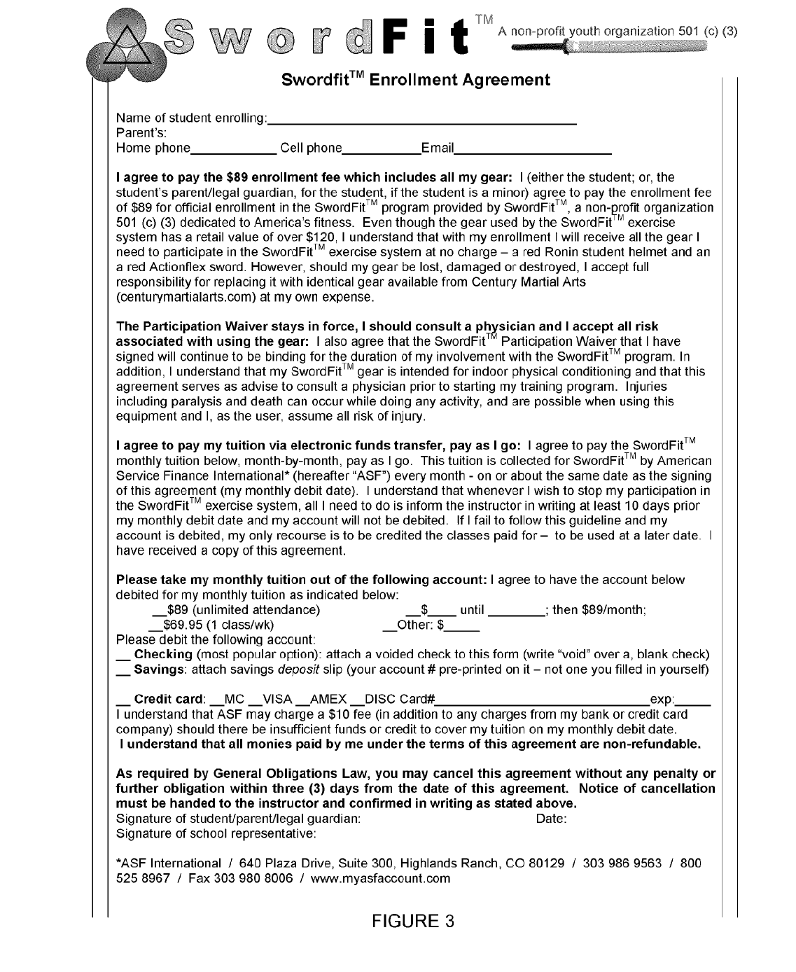

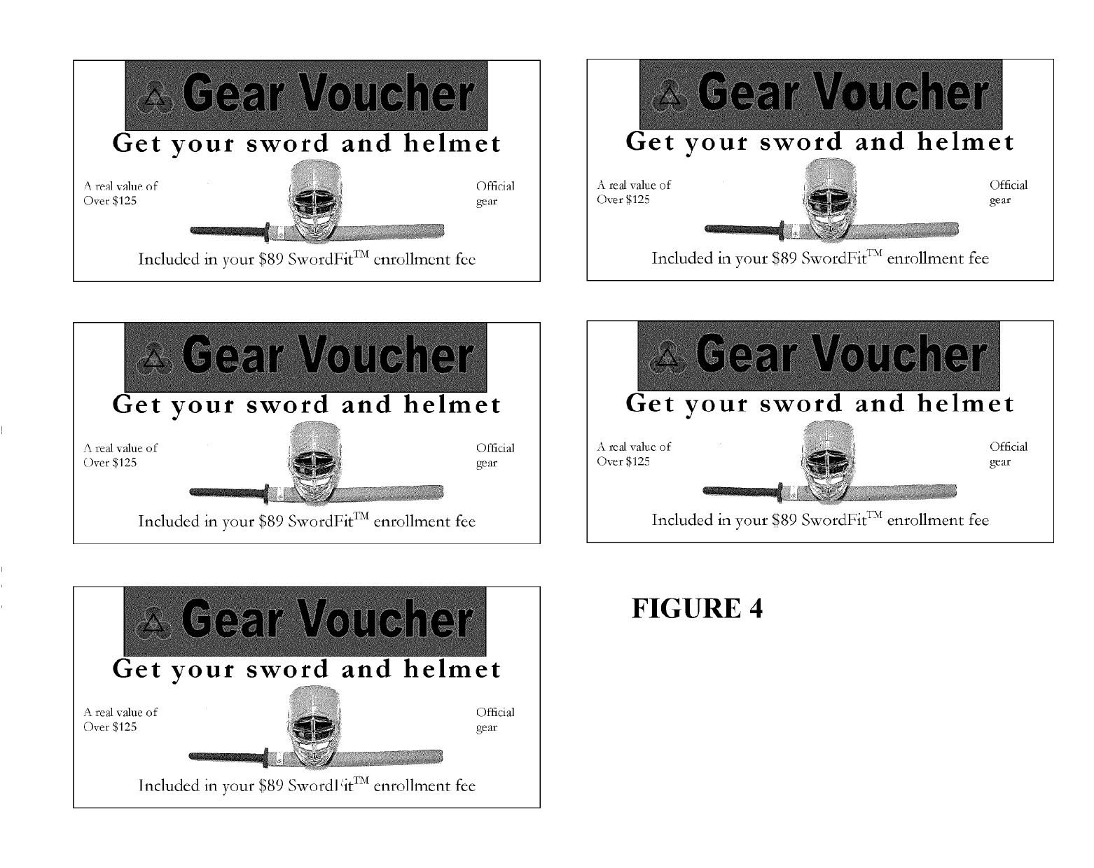

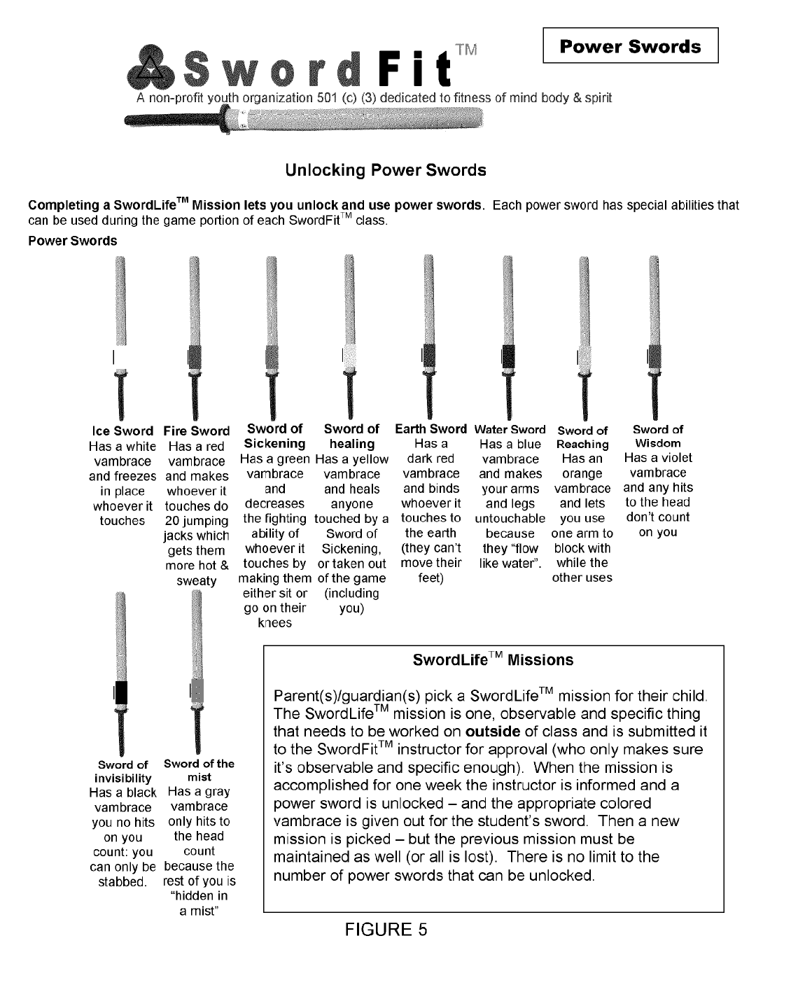

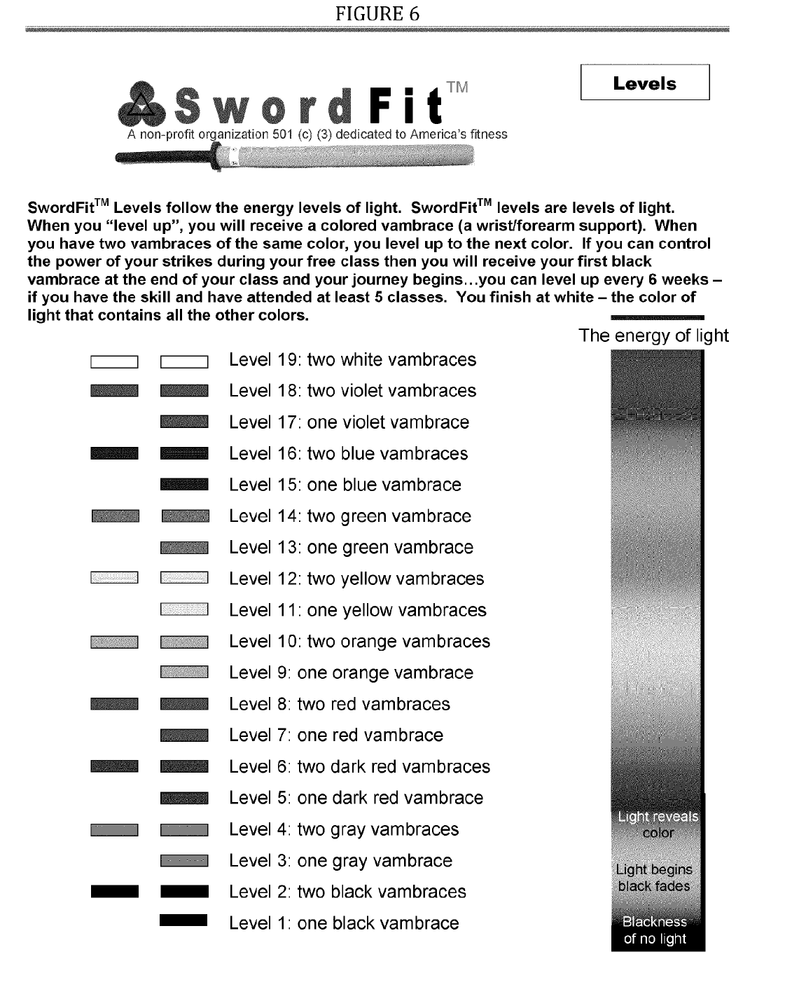

1) 1 medium tipped, black, permanent marker; 2) 1 medium tipped, red permanent marker; 3) 1 student roll book; 4) 5 medium point blue stick pens; 5) 20 blank SwordFit® student participation waivers (see FIG. 2), 6) 40 blank SwordFit® enrollment forms (see FIG. 3), 7) 3 gray clipboards, 8) 20 SwordFit® Gear Voucher cards (see FIG. 4 attachment 4). 9) 20 SwordFit® PowerSword™ handouts (see FIG. 5) 10) 20 SwordFit® Levels handout (see FIG. 6); 11) SwordFit® Curriculum (see below); 12) zippered “bank bag” for cash & checks received. 23) White plastic, double-faced, A frame sign with “SwordFit® Taught Here on each side” with small hook attached to left side of one face.

24) Plexiglas single brochure holder display

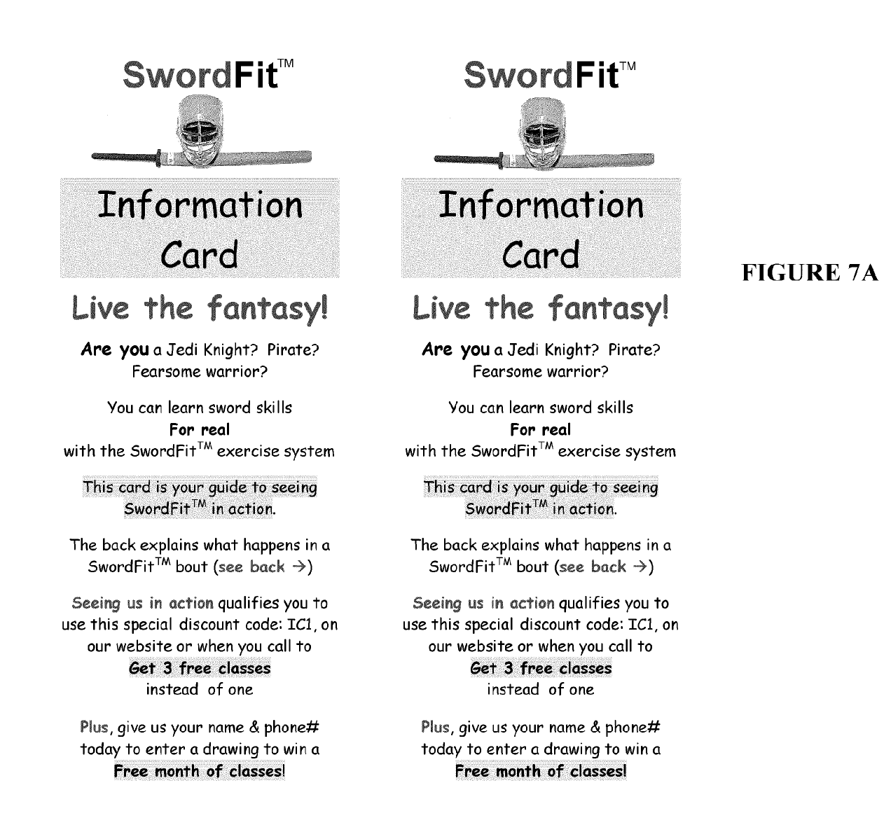

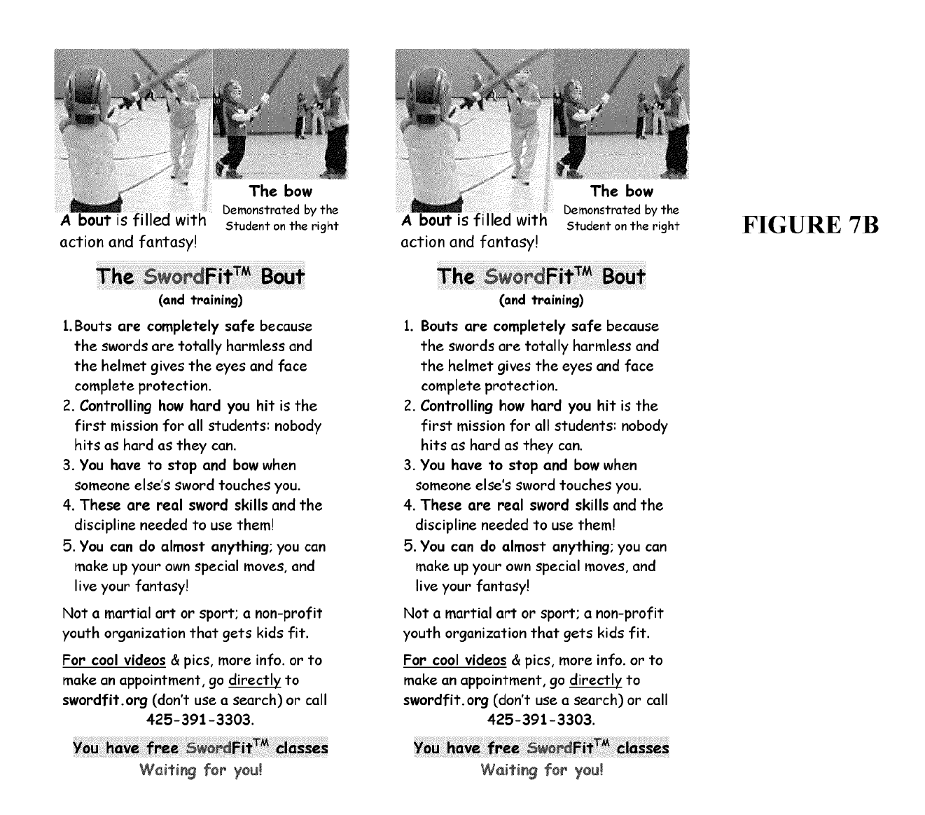

25) 20 SwordFit® information cards (to go in brochure holder) (see FIGS. 7A and 7B.)

26) Two XL REI Black Duffle bags containing:

1. First bag: 8 red Ronin helmets and 5 red Actionflex swords;

2. Second bag: remaining items listed above.

1. Participant materials

1) All: Either 1 S/M or 1 L/XL (student's preference) red Ronin helmet

2) All: Red 40″ Actionflex sword (included in enrollment fee—currently $89)

3) Disciples/Masters only: Appropriately colored hakama (according to level) (included in enrollment fee—to be determined)

4) Masters only: appropriately colored, traditional, medium weight, martial arts uniform jacket (included in enrollment fee—to be determined)

2. Administrator materials

1) SwordFit® charter letter authorizing the “running” of a local SwordFit® “chapter”.

2) Computer (Apple preferred) with high-speed internet connection and Microsoft Word, an accounting software package (iBank preferred), and a photography application (iPhoto preferred).

3) 2 business checking and 2 business savings accounts in the name of “SwordFit® of ______”, where the “______” is filled in with the town/locality where administrator is running a SwordFit® chapter.

4) American Service Finance account number and password for your SwordFit® chapter

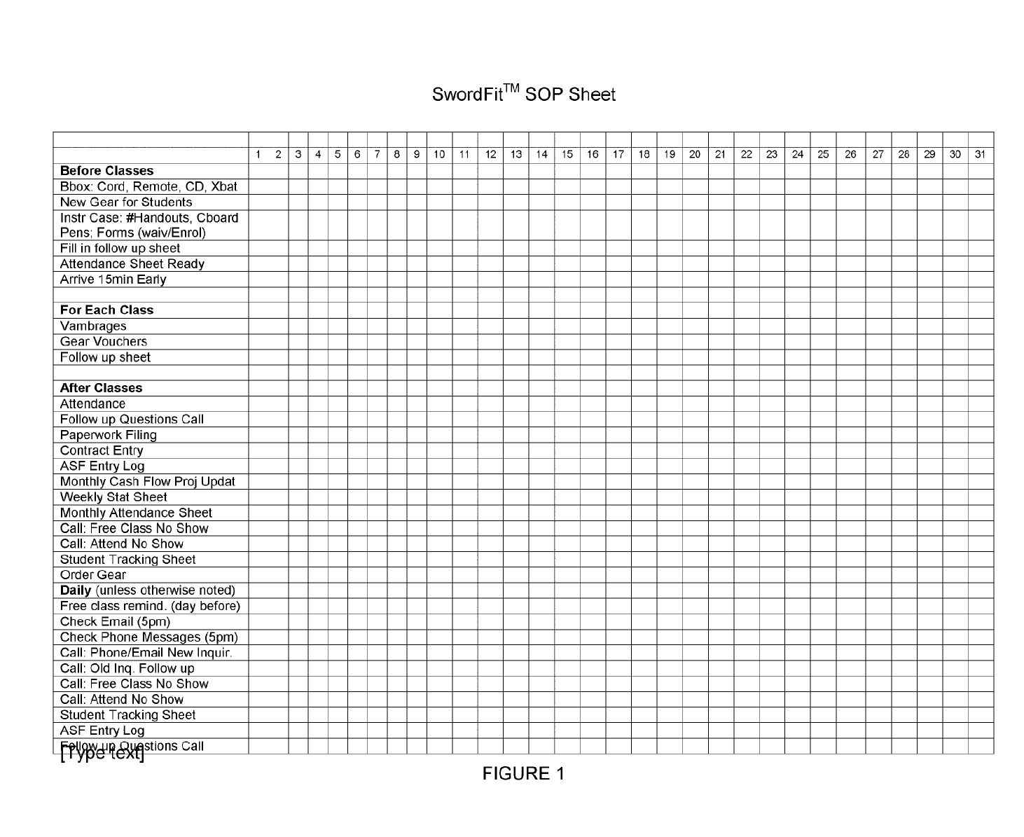

5) SwordFit® Standard Operating Procedures (SOP) sheet (see FIG. 1.)

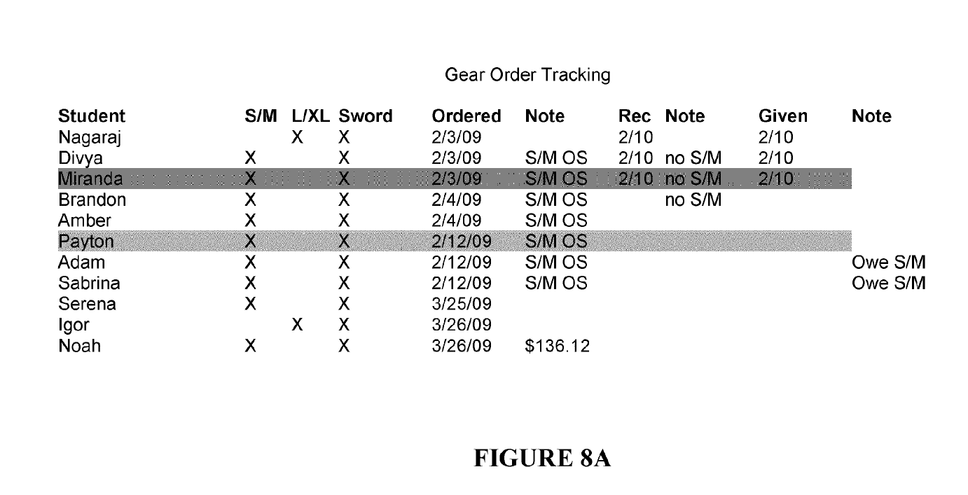

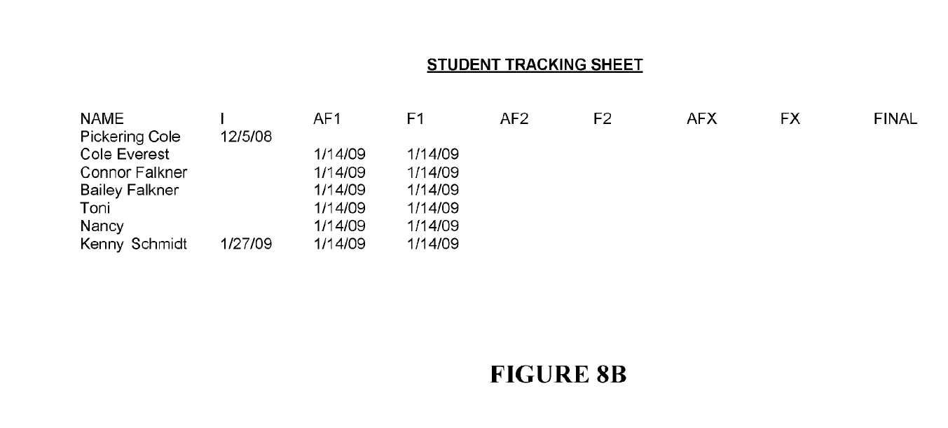

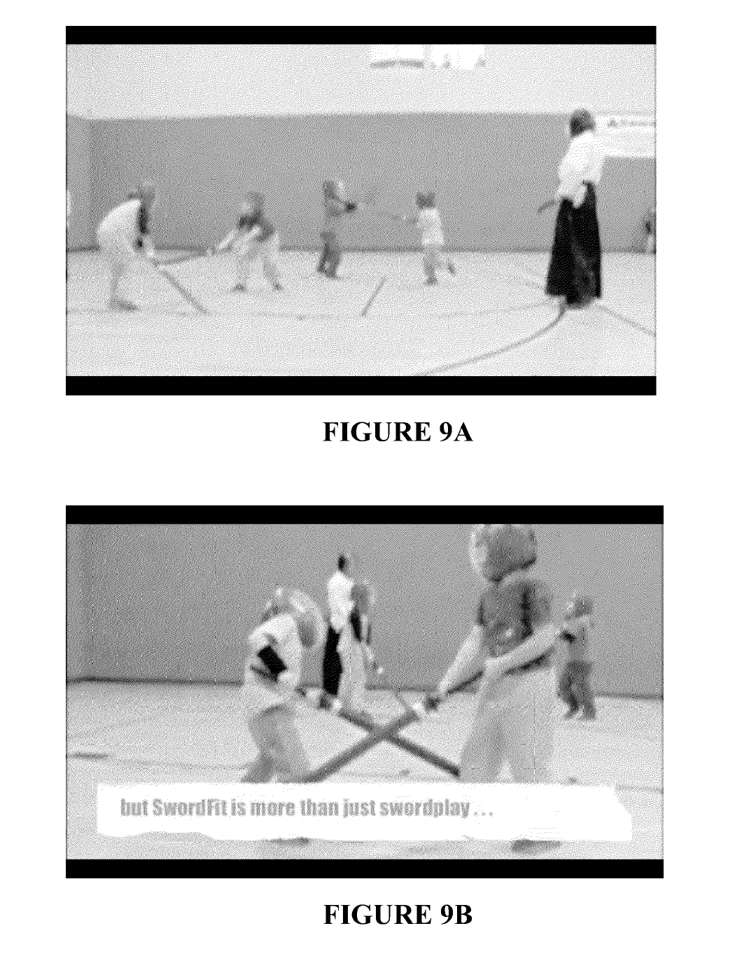

6) SwordFit® Administrative Tracking System sheets (see FIGS. 8A and 8B.)

II. Swordfit® Educational Method™

A. Traditional categorization.

1. Event though the SwordFit® Educational Method™ is unique, from a perspective of traditional educational methods, the SwordFit® Educational Method™ might be considered as utilizing three identifiable educational theories or philosophies:

a. Educational progressivism (learn by doing): swordplay is a skill that evidences itself in action, and the action of Swording™ is the learning medium;

b. The Constructivist approach to learning (the generation of knowledge and meaning from experience): the physical, mental and emotional skills conveyed by the SwordFit® Exercise System™ are confirmed by, and given meaning through, each participants own experience; and,

c. Outcome-based education (an objectively measurable/observable outcome): the outcome of the SwordFit® Exercise System™ is a practitioner who can be objectively observed to demonstrate the physical skill taught at each SwordFit® level.

d. However, the SwordFit® Educational Method exceeds these categories by virtue of its most salient characteristic: encouragement. For this reason

B. The SwordFit® Educational Method™: Encouragement Centered Education™

1. Encouragement Centered Education™ is an educational system developed by the founder of SwordFit® over a lifetime spent in the field of education.

a. Distinguishing and identifying characteristics

1) Preferably all interactions with the student are positive and encouraging (an instructor should never, under any circumstances, have an interaction with a student that is not positive and encouraging.

a) Even undesirable behavior or incorrect performance is addressed in an encouraging and positive manner.

b) This is based on the founder's belief that the act of encouraging has an expanding effect on a person's spirit, and that expansion is an inalienable characteristic of learning, which is the desired result of education.

c) It is also based of the founder's belief that the act of encouraging builds a person's confidence, and that confidence is the key to expansion and learning without traumatizing a learner's spirit.

d) Finally, it is based on the founder's belief and experience that when learning takes place in a confident learner, and in an atmosphere that is encouraging and free of trauma then learning becomes an enjoyable experience that the learner looks forward to repeating—which, when combined with an inherently enjoyable subject matter (swordplay), results in retaining the student's interest in the learning activity over a much greater period than would otherwise be possible.

2. SwordFit's® Encouragement Centered Education™ method is the only educational method encouraged for use by SwordFit® instructors for delivering the SwordFit® curriculum.

C. Application of SwordFit's® Encouragement Centered Education™ method in the SwordFit® Exercise System.

1. The instructor is responsible for encouraging every student, in every class, by acknowledging her/his effort at learning an acquiring the skill required for that student's next SwordFit® level.

a. A red “level skill” headband is placed around the helmet of every student encouraged who successfully performs the skill for his/her next level.

2) Every student should have one around his/her helmet by the end of the class.

2. The instructor is responsible for using, in this example, four forms of encouragement utilized in SwordFit's® Encouragement Centered Education™ method.

a. Direct encouragement from the instructor: “stop, touch, name, praise & continue” 1) Stop: Instructor steps between students to stop them.

2) Touch: Instructor gets eye level with the student(s) being praised and makes eye contact and touches the student(s) on the shoulder.

3) Name: Instructor uses the name(s) of the student(s).

4) Praise (verbal & physical): Instructor gives verbal praise for a specific action (usually a level skill), followed by the physical praise of awarding the red “level skill” headband.

5) Continue: Instructor encourages the student(s) to use that good effort in the rest of class.

b. Corrective Questioning™ from the instructor: “stop, touch, name, question, praise & continue”

1) Stop: Instructor steps between students to stop them.

2) Touch: Instructor gets eye level with the student(s) being praised and makes eye contact and touches the student(s) on the shoulder.

3) Name: Instructor uses the name(s) of the student(s).

4) Question: Instructor asks student if she/he can perform the desired action by modeling the desired action personally; or having the student do so (usually a level skill; but may also be a classroom management or other issue).

5) Praise: The instructor watches for any effort (no matter how small) and immediately praises the student (first stopping and touching of course) both verbally by praising the specific action the instructor saw; and physically by awarding the “level skill” headband.

c. Direct peer encouragement from other students: at the end of each section of class, the class applauds every student who received a “level skill” headband during that section of class.

d. Encouragement from instructor modeling: the instructor encourages the desired behavior (usually a sword skill) by modeling it (the students naturally want to be like the teacher).

e. Encouragement from peer modeling: the students encourage the desired behavior

1) When the instructor has the class sit to watch selected students model the desired behavior—usually a sword skill (the students want to be praised in front of the class).

2) When the instructor points out a student/students demonstrating the correct behavior to encourage other students to emulate it—usually during line up (students want positive attention from the instructor). This is followed by pointing out the behavior of each student—as it conforms to the correct behavior (using the student's name).

III. The SwordFit® Curriculum

A. Overview: SwordFit® Instructors will deliver, and participants will progress through, three different stages of a scaffolded and differentiated curriculum, which end at the Master stage. Each stage lasts approximately 2¼ years for a total elapsed training time of no less than 7 years from beginning training as a student to reaching the stage where one is considered a SwordFit® “Master” or Swordingmaster™

1. The Student, or Swordant™ Stage

a. The Swordant™ Stage of the SwordFit® Curriculum is divided into 19 levels, as represented by the SwordFit® Levels handout (see FIG. 6). Placing the appropriate LevelRings™ onto the blade of the SwordFit® SoftSword designates each of the 19 levels.

b. Dress: no uniform—regular clothes.

c. Designation: Sworders™ in this stage may be collectively referred to as “Swordants™”; or, in lieu of either their given or SwordFit® name, may be referred to individually as “Swordant™” (though this pronoun should be rarely used when speaking directly to a Sworder™—because it is not as encouraging as using someone's given or SwordFit® name).

d. Fundamental sword skills are required for level advancement: grip, stance, etc.

e. Higher purpose begins to be developed through informal mentoring via encouragement to become a “Knight” by taking on an “apprentice”.

f. Personal improvement through SwordLife™ missions.

2. The Practitioner, or Swordarion™ Stage

a. The Swordarion™ Stage of the SwordFit® Curriculum is divided into 19 levels in the exact same way that the Swordant™ stage is divided.

b. Dress: red hakama (martial arts “skirt”): the wearing of the red hakama distinguishes Swordarions™ from Swordants™

g. Designation: Sworders™ in this stage may be collectively referred to as “Swordarions™”; or, in lieu of either their given or SwordFit® name, may be referred to individually as “Swordarion™” (though this pronoun should be rarely used when speaking directly to a Sworder™—because it is not as encouraging as using someone's given or SwordFit® name).

c. Mental sword skills are required for level advancement.

d. Higher purpose development is refined through formal mentoring as an assistant to a SwordFit® instructor during part and/or all of one or more classes (introduced to principles of Encouragement Centered Education™); informal mentoring of apprentice(s) continues.

e. Continued personal improvement through SwordLife™ missions.

f. Higher purpose is expanded through individual community service (either individually or as a member of service project organized by a SwordFit® Swordbearer™

3. The Artist, or Swordbearer™ Stage

a. The Swordbearer™ Stage of the SwordFit® Curriculum is divided into 19 levels in the exact same way that the previous stages are divided.

b. Dress: black hakama: the wearing of the black hakama distinguishes Sworders™ in the Swordbearer™ stage. Additionally, Swordbearer™ are allowed to “wear” the sword by affixing it to the ties of the hakama; red shirts/tops cannot be worn due to giving the inappropriate image of wearing the black & red colors of a Swordingmaster™

c. Designation: “Swordbearer™” follows the participant's name.

d. Emotional/spiritual sword skills are required for level advancement.

g. Continued personal improvement through SwordLife™ missions, which become self-assigned.

e. Advanced development of higher purpose through leadership development resulting in organizing and executing group-effort community service.

4. The Master, or Swordingmaster™ Stage

a. Dress: black hakama with red jacket and is allowed to “wear” the sword (note: as SwordFit® Masters, the founder and his bloodline wear a white jacket with the black hakama).

b. Designation: “Master” followed by the participant's SwordFit® name.

c. This stage represents the completion of the SwordFit® curriculum, though SwordFit® Masters are welcome to participate in SwordFit® functions and classes.

B. SwordFit® Terminology

1. Unique and specialized (trademarked) terminology

a. SwordTalk™, or Swordlish™, is the Unique and Specialized (trademarked) Terminology used by SwordFit® and its personnel and participants.

b. A Sworder™ is a SwordFit® participant (whether Swordling™, Swordent™, Swordarion™, Swordbearer™ or Swordingmaster™)

c. A Swordling™ is a Sworder™ who is too immature (usually 4-6 yrs of age) for the regular SwordFit® curriculum and attends shorter training sessions.

d. A Swordant™ is a “student” of Swording™ and is training in the first stage of the SwordFit® curriculum.

e. A Swordarion™ is a “practitioner” of Swording™ and is training in the second stage of the SwordFit® curriculum.

f. A Swordbearer™ is an “artist of Swording™” who is training in the third and final stage of the SwordFit® curriculum and is qualified to “wear” the sword by inserting in into a “long” headband affixed to the hakama and of the same color as the hakama.

g. A Swordingmaster™ is a “master” of Swording™ who has for example completed three stages of the SwordFit® curriculum.

h. A Swordsei™ is the term for a SwordFit® Instructor and used by Sworders™ as a form of address. It is, derived from sen-sei (a Japanese martial arts term: sen=previous; sei=birth and used to designate a martial arts teacher); thus, Swordsei (containing the English root word “sword” and the Japanese word for “born” or “birth”) means “sword-born” or “born of the sword”.

i. Swording™ is using the sword in the SwordFit® Exercise System™—in whatever capacity.

1) Takes the place of “sword fighting” which sounds too violent; and, “swordplay” which sounds too babyish.

j. Swordarium™ is the term for the place or facility where either a SwordFit® class or event is held; or, anywhere Swording™ occurs.

k. FreeBout™ is the 1st section of a SwordFit® class in which Sworders™ are free to do Swording™ in any manner they wish (as long as the obey the Swording Code™)

l. SwordingSkills™ is the 2nd section of a SwordFit® class in which Swording™ touching or defensive, strategies, techniques and combinations are taught.

m. A SwordSkill™ is also the term used to designate a single touching or defensive, strategy, technique or combination (also known, collectively, as SwordSkills™)

n. PowerUp™ is the 3rd section of a SwordFit® class where supplementary strengthening exercises are performed whenever the music stops, for as long as it stops.

o. The Swordario™ is the 4th and final section of a SwordFit® class in which the students are given a “game” scenario to play out.

p. A SwordingCycle™ is a SwordFit® synonym for “semester” or “training period”. It is a period of training that is 6 weeks long; during which a single lesson plan is conveyed to the Sworders™ by the SwordFit® Instructor.

q. A PowerSword™ is a sword that is given special powers by virtue of its PowerBand™. These powers are used during the last, game portion of class.

r. PowerBands™ are “long”, colored wrist bands that are placed on the blade of the sword that signify what special powers the sword has during the gaming section of the class.

s. SwordFit® has three different meanings

1) The name of the non-profit organization

2) The physical activity of training using the SwordFit® Exercise System™.

3) The physical fitness that results from Swording™

t. The SwordFit® Exercise System™ is a synonym for SwordFit® as it is used to describe the physical activity of training. The SwordFit® Exercise System™ is used in place of SwordFit® when the intention is to convey that SwordFit® is an organized and systematic program of exercise that has a definite intention and curriculum.

u. SwordWay™ is both the philosophy of self-development contained in the SwordFit® Creed (simply called “The SwordWay™); and, the basic principles of using the sword as taught in the SwordFit® Exercise System™ curriculum.

1) A Stephold™ is each concept contained in the philosophy of the SwordWay™.

2) A Codah™ is a one sentence, understanding of a SwordWay™ concept.

3) SwordLife™ is the process of applying SwordWay™ to your life to grow emotionally/spiritually. This occurs in a progressive and scaffolded manner, first through the SwordLife™ missions given by the parent to the SwordFit® student; then through individual acts of community service; and, finally, through organizing and leading acts of community service and SwordLife™ missions determined by the students themselves.

4) The Principles of Swording™ are the basic principles of using the sword that are part of the SwordWay™ and are taught at, and are specific to, each SwordFit® level.

v. SwordLife™ Mission is the observable behavior modification requested by the parent (or; later, by the Sworder™) that must be completed in order to unlock a PowerSword™

w. SwordLife Service™ is when a Sworder™ “serves the land” (her/his community) either through individual acts of service, as part of a group, or as an organizer/leader of a group performing an act of community service.

x. A PowerSword™ is an Actionflex sword with one or more PowerRings™ slid onto the “blade” above the SwordRings™, but below any Touchcounters™.

y. PowerRings™ are “long”, colored wristbands that slide onto the “blade” of an Actionflex sword, above the SwordRings™, but below any Touchcounters™. The color of the PowerRing™ signifies what special abilities the sword has—or gives its wielder—during the game portion of class.

z. LevelRings™ are the wristbands that are placed around the sword to signify which level a participant is at.

aa. Touchcounters™ are additional wristbands added to the sword that a student may remove when touched instead of being “out” during the challenge round of class.

bb. SwordRealm™ is the fantasy construct of the SwordFit® Exercise System™.

cc. Encouragement Centered Education™ is the unique educational theory used by a Swordsei™ to implement the SwordFit® curriculum.

dd. SwordAid™ is a Swording™ event to raise money for a charity, service project, or other cause.

2. Non-trademarked SwordFit® specific terminology

a. “SoftSword” is the SwordFit® term for the Actionflex padded weaponry sword.

b. A “Bout”: is a period of Swording™ between two Sworders™

c. A “Training Bout” is a period, or periods, of Swording™ where the participants are encouraged to engage in Swording™ along the guidelines laid down by the instructor.

d. “Touching” and “Touch” are terms used by SwordFit® as a synonym for strike and/or attack—which convey too much violence.

e. The term “Level” is leveraged from both video games and role-playing games and serves many purposes within both the SwordFit® Exercise System™ and the SwordRealm™.

C. The Four Divisions of the SwordFit® Curriculum

1. SwordFit® is the physical aspect of training in the SwordFit® Exercise System™ and is composed primarily of the aerobic exercise inherent in Swording™, supplemented by SwordSkills™ and some strength training during the “power-up” section of class.

2. SwordWay™ is the philosophy of SwordFit® conveyed during the SwordWay™ section of the class in which the meaning and application of SwordWay™ is discussed with the students; it is also the fundamental principles of Swording™ required for advancement at each level.

3. SwordLife™ carries SwordWay™ out of the SwordFit® class and into the student's life. SwordLife™ has two different aspects.

a. SwordLife™ missions

1) Used to unlock power swords. At first these are set by the parent(s)/legal guardian(s) of the student; and, later, by the student her/him self.

b. Community service

1) Begins with the student leading him/her self and ends with the student organizing and leading others.

4. SwordRealm™ is the fantasy construct of the SwordFit® Exercise System™, which is used to activate the imagination in a natural way already used by kids; it is also designed to leverage the role-playing fantasy construct used directly in video games, and indirectly in movies and on T.V.

D. SwordFit® The Physical Curriculum

1. The SwordFit® physical curriculum is the aerobic exercise inherent in Swording™ supplemented with SwordingSkills™ and strengthening exercises.

a. To participate in Swording™ Sworders™ follow the Swording Code™

1) Respect and obey the instructors—always answer with “Yes, Swordsei™!”, or, “No, Swordsei™!”.

2) Respect and protect your partner.

3) When the music stops, Swording™ stops.

4) Touch “nicely” with your sword—be respectful, don't hit as hard as you can.

5) Bow nicely and fully whenever your partner's sword touches you.

6) Both partners bow if they both touch each other at the same time.

7) Bow if you are touched first even if you touch your partner an instant later, you are the only one who bows.

8) Let your partner bow and then get ready after you make a touch by crossing swords before you continue Swording™

9) If you partner needs help in following the Swording Code™, stand still and raise your arm and point your sword straight up until an instructor or an assistant comes over to help.

a) Sworders™ who need help in following the Swording Code™ will be encouraged to follow the Swording Code™ by sitting and watching how other Sworders™ follow the code.
(1) The instructor will touch the Sworder's™ shoulder and say, “[Name of Sworder™] you're getting better at Swording™ every time I watch you. To make sure you keep getting better, I want you to sit and watch for a while how other Sworders™ are [state the correct Swording™ action]. When the music stops, look at me, if you see me look at you and nod my head, then it'll be time for you to start Swording™ again. I know you'll be able to learn this, so just take off your sword and helmet, set them on the floor beside you without touching them; and, if you sit completely still, like you're frozen, and watch the class, I'll nod to you to rejoin just as soon as I think you're ready, okay?”

b. Delivery of the aerobic activity inherent in Swording™

1) During the 1st Free Bout section of class, the instructor will deliver the aerobic activity inherent in Swording™ to the general class, without interruption, during approximately the first 10 minutes of class.

2) During the 2nd PowerUp™ section of class, the instructor will deliver the aerobic activity inherent in Swording™ to the general class, interrupted only by the supplemental strengthening exercises (signaled to begin by the music stopping—either between the natural 1 min. intervals; or at the instructor's will), during approximately the second 10 minutes of class.

3) During the 3rd SwordSkills™ section of class, the instructor will deliver the aerobic activity inherent in Swording™ to the general class during the 1 minute musical selections without interruption, during approximately the next 5 minutes of class.

4) During the 4th Swordario™ section of class, the instructor will deliver the aerobic activity inherent in Swording™, without interruption during each musical selection.

c. SwordingSkills™ are Swording™ touching and defensive, strategies, techniques and combinations.

1) A SwordSkills™ “unit” is 5 weeks long (the first of the six weeks of a SwordingCycle™ has no SwordingSkills™ due to the first, FreeBout™ section of the class being extended for the purpose of evaluating Sworders™ who are leveling-up).

a) SwordSkill™units are taught by the Swordsei™ sequentially in the order that follows (when the sequence is completed it is repeated):

(1) Defensive Swording™ blocks and blocking strategy.

(2) Full-arched and small-arched, 2 touch combinations.

(3) Defensive Swording™ evasions and evasion strategy.

(4) Full-arched, 2 touch combinations.

(5) Defensive Swording™ disruptions and disruption strategy.

(6) Touching movement strategies.

(7) Defensive interruptions and interrupting strategies.

(8) 3 and more touch combinations.

b) Completing for example 8 of the SwordSkill™ units can take a full year, so by the time the Sworder™ encounters the material again it will be engaged at a new skill level where new insights will make the material “ever-fresh”.

2) Each week of the 5-week SwordSkills™ unit teaches a different SwordSkill™

3) Specific SwordSkills™ are currently in development.

d. Delivery of the SwordSkills™

1) First, encouragement for correctly performing each SwordSkill™ is provided by the Swordsei™, who models the skill to the class of seated Sworders™. The Swordsei™ may accomplish this with or without a partner.

2) Next, the Sworders™ pair up and one side practices the SwordSkill™; this may or may not involve an initiating action from the other partner (as is the case where a defensive skill is being practiced). During the time, the Swordsei™ goes from pair to pair to encourage correct performance. This usually lasts for the length of a single bout (about 1 min.).

3) Next, the Sworders™ switch roles so that the other partner practices the SwordSkills™. Again the Swordsei™ goes from pair to pair encouraging. This usually lasts for the length of a single bout (about 1 min.).

4) Next, the Sworders™ are seated with their partners for peer encouragement as the instructor asks a Sworder™ who has been observed as performing the SwordSkills™ particularly well to demonstrate with her/his partner. Depending on time, this may be repeated with another Sworder™ being asked to demonstrate.

5) Next, Sworders™ alternate back and forth practicing the technique for a single bout.

6) Finally, the Sworders™ alternate back and forth practicing the technique, but while moving around the Swordarium™ in the same way they would during a FreeBout™

e. The aerobic exercise inherent in Swording™ is supplemented by strength training

1) Official SwordFit® strength training exercises are still in the process of development. Until such time as development is complete, the instructor is free to choose any type of body strengthening exercise that can be safely and competently performed, solo, by a 4 year old and that requires no extraneous gear.

f. Delivery of the supplemental strength training

1) The instructor will deliver the supplemental strength training at the following times during the Power-Up rounds only:

a) After the 1st musical selection of the Power-Up round is finished (this time can be extended, but should not go beyond the consistent efforts of the bulk of the class; e.g., when most of the class has given up or significantly decreased their performance of the supplemental exercise).

b) At the instructor's best estimate of the halfway point of the 2nd musical selection of the Power-Up round.

c) Whenever the music stops between Power-Up rounds (this time can be extended, but should follow the same guidelines as in a), above.

d) After the 2nd musical selection is finished, the instructor may pause the music at anytime, and as many times as she/he deems appropriate as long as the length of time devoted to the strengthening exercises during each stoppage does not violate the guidelines set forth in a), above.

E. SwordWay™: The Philosophical Curriculum

1. Each SwordWay™ philosophical lesson is 6 weeks long: both congruent and concurrent with the SwordWay™ Principles of Swording™ lesson plan.

2. After the SwordWay™ philosophical lessons have been delivered by the instructor to the class, the lesson cycle is repeated from the beginning

3. SwordWay™ philosophical lessons are constructed around the SwordWay™:

a. “I will battle: selfishness, carelessness, laziness, rigidness and violence; and I will strive to think and act with: higher purpose, preparation, discipline, responsiveness and love.”

4. SwordFit® Instructors will deliver the SwordWay™ philosophical lessons using the following procedure:

a. The first 4 weeks of the 6 week SwordingCycle™

1) The SwordFit® Instructor will say to the students, “Repeat after me”

2) The Instructor will then say the first part of the SwordWay™ Codah™ appropriate for the current SwordingCycle™; the Sworders™ will repeat this first part of the Codah™

3) The Instructor will then say the second part of the SwordWay™ Codah™ appropriate for the current SwordingCycle™; the Sworders™ will repeat this second part of the Codah™

4) This process is then repeated.

5) The SwordFit® Instructor will then ask the Sworders™ “What is [the StepHold being covered]”; the Sworders™ then repeat, in answer, the second part of the Codah™

6) The instructor will then, briefly, share a fictional story of how this Stephold™ might come up in life.

b. The last 2 weeks of the 6 week SwordingCycle™

1) The SwordFit® Instructor will begin as she/he ended in the previous 4 weeks: by ask the Sworders™ “What is [the StepHold being covered]”; the Sworders™ then repeat, in answer, the second part of the Codah™

2) The SwordFit® Instructor will then repeat this process.

3) The instructor will praise the students, and then (for the benefit of any Sworders™ who have not learned the Codah™) yet, the instructor will say, The SwordFit® Instructor will say to the students, “Repeat after me”

4) The Instructor will then say the first part of the SwordWay™ Codah™ appropriate for the current SwordingCycle™; the Sworders™ will repeat this first part of the Codah™

5) The Instructor will then say the second part of the SwordWay™ Codah™ appropriate for the current SwordingCycle™; the Sworders™ will repeat this second part of the Codah™

6) The instructor will then ask the Sworders™ if two of them have a real-life story to tell about how they either did or, did not, use this Stephold™ in their own lives.

7) After each story, the instructor will then repeat, very loudly, so that students—and parent(s) and/or guardian(s) present can hear, the gist of the story.

8) After each story, the instructor will then ask for peer praise for the story by asking everyone to “give [name of Sworder™] a hand for sharing that story!”

9) If no stories, or just one story, is offered by the Sworders™, then the instructor will briefly relay a fictional story of how this Stephold™ might come up in life.

5. The SwordFit® Instructors will deliver the SwordWay™ philosophical lessons, through the procedure described in 4., above, by using the following SwordWay™ Codahs™.

a. Part one of each Codah™ is separated from part two by a “/”:

1) SwordWay™ Codah™ #1: “Selfishness is/thinking only about yourself!”

2) SwordWay™ Codah™ #2: “Carelessness is/not caring enough to do something right!”

3) SwordWay™ Codah™ #3: “Laziness is/not working hard enough, to do what you should do!”

4) SwordWay™ Codah™ #4: “Rigidness is/sticking with one way of doing something, even if it's not the best way!”

5) SwordWay™ Codah™ #5: “Violence is/hurting someone's body or feelings!”

6) SwordWay™ Codah™ #6: “Higher purpose is/setting goals to do good that goes beyond yourself!”

7) SwordWay™ Codah™ #7: “Preparation is/planning the best way to reach a goal!”

8) SwordWay™ Codah™ #8: “Discipline is/doing what you should do, especially when you don't want to!”

9) SwordWay™ Codah™ #9: “Responsiveness is/being creative, flexible and positive in finding the way to reach a goal.

10) SwordWay™ Codah™ #10: “Love is/the action of positive giving!”

F. SwordWay™: The Principles of Swording™—The “Lessons” of SwordFit®.

1. Pedagogically, the SwordWay™ Principles of Swording™ are the “Lessons” of the SwordFit® Exercise System™, because:

a. The Principles of Swording™ are the subjects of the assessment that determines whether a Sworder™ advances to the next SwordFit® level.

b. The Principles of Swording™ are the sole focus of differentiated instruction during each SwordFit® class.

c. The Principles of Swording™ are the sole focus of scaffolding in the SwordFit® Exercise System™

d. The Principles of Swording™ are the primary factors (along with the appropriate time spent in practice—of course!) that are responsible for producing the observable sword skill outcome of SwordFit® training, namely:

1) Higher level Sworders™ possess increasingly greater skills that make them more difficult to be touched by lower level Sworders™

2) Higher level Sworders™ possess increasingly greater skills that make it easier for them to touch lower level Sworders™ than it is for Sworders™ of the same or closely associated levels to touch these same Sworders™

3) Higher level Sworders™ can be observed by those well-versed in the sword arts (especially with the Japanese Samurai sword) to display a more effective grasp of classically correct sword skills than those of lower levels.

4) Through correct and diligent application of these Principles of Swording™, Sworders™ will advance to the point of being recognized as masters of the Japanese Samurai sword (insofar as it is expressed through realistic contest with padded weaponry) by SwordFit® their peers and others who engage in padded weaponry practice with the sword.

2. Delivering the SwordWay™ Principles of Swording™

a. Each lesson lasts for one SwordingCycle™, which is 6 weeks long.

b. The instructor will convey the level appropriate Principle of Swording™ orally to each student/or small groups of students, and will reinforce this lesson throughout the class—and throughout the Swording Code™—by either direct encouragement (if the student is already executing the lesson correctly; or, by corrective questioning if the student needs to be encouraged to correct their swording).

1) Each lesson is introduced directly to the student(s) by the instructor using the following process (essentially corrective questioning with the praise & question switching places):

b) “Stop, touch, name, praise, question & continue”

(1) Stop: as per direct encouragement corrective questioning.

(2) Touch: as per direct encouragement corrective questioning.

(3) Name: as per direct encouragement corrective questioning.

(4) Praise: congratulate student on achieving the next level (be specific in naming the level).

(5) Question: ask the student (verbatim) “Are you ready to practice the next level of swording skill by [describe & model the skill]?”

(6) Continue: tell the student to (add this verbatim) “ . . . practice this new skill every chance you get—you'll need to demonstrate it to get to your next level”.

2) Lessons are not revealed to the students ahead of time (i.e. in written form on a handout or on the website); but are conveyed to the student individually; however, in some circumstances the lesson is conveyed to a group of students working on the same lesson.

a. Not revealing the nature of the skill levels to the students ahead of time keeps the learning “fresh”, and thus more exciting.

c. Lesson assessment occurs during 1st week of the new SwordingCycle™, and is called “level-up” week.

1) A small square of silver duct tape (known as a “level-up marker” is placed on the student's helmet, in the center, just below the nameplate (or nearby if the student is a “knight” and thus already has a piece of black duct tape in that location).

d. “Level-up”, in which students are actually awarded their next level SwordRings™ occurs during the 2nd week of the SwordingCycle™

1) Class pictures are also taken at the end of each of these classes and are submitted as press releases to the local paper.

3. SwordWay™ Principles of Swording™ for Students: Swording™ fundamentals

a. Lesson Plans for Black & Gray SwordRings™: Swording™ sword position

1) Level one: Hold sword in center of your body.

2) Level two: Aim the sword tip to your partner's eyes.

3) Level three: Keep your arms straight (but not “locked”—elbows joint relaxed).

4) Level four: Keep the end of the hilt a fist-width away from your body.

b. Lesson Plans for Dark red & Red SwordRings™: Swording™ stance

5) Level five: Keep one leg forward and the same arm forward.

6) Level six: Keep your feet shoulder-width apart.

7) Level seven: Keep you feet a normal step's-length apart.

8) Level eight: Keep both knees bent.

c. Lesson Plans for Orange & Yellow SwordRings™: Swording™ grip

9) Level nine: Rear sword hand—keep the end of the hilt in line with the rear edge of your rear hand.

10) Level ten: Front sword hand—keep the front hand at the tsuba.

11) Level eleven: The tips of your thumbs and index finger should be touching so that you are NOT gripping the sword with either your thumb or your index finger.

12) Level twelve: Keep the front hand so that the middle knuckle of the index finger touches the tsuba; but so a ping-pong ball could fit between the base knuckle of the thumb and the tsuba.

d. Lesson Plans for Green & Blue SwordRings™: Swording™ feet and body details

13) Level thirteen: Keep the heel of the front foot turned out.

14) Level fourteen: Keep the heel of the back foot turned in.

15) Level fifteen: Keep the weight centered.

16) Level sixteen: Keep the back straight and the shoulders relaxed.

e. Lesson Plans for Violet SwordRings™: Swording™ sword handling subtleties

17) Level seventeen: Front hand 20% & is used for “steering” the sword.

18) Level eighteen: Back hand 80% & wrist is loose and supple.

f. Lesson Plans for White SwordRing™: Swording™ touching subtleties

19) Level nineteen: “Wringing” the sword on the touching stroke.

4. SwordWay™ Principles of Swording™ for Swordarions™: Swording™ from different positions or stances.

a. Lesson Plans for Black & Gray SwordRings™: Swording™ from the “low position”.

1) Level one: Right leg forward low position as the ready position

2) Level two: Left leg forward low position as the ready position

3) Level three: Alternating between right & left leg forward low positions as the ready position.

4) Level four: Integrating low and center positions (going from center to low ready positions and vice-versa).

b. Lesson Plans for Dark Red & Red SwordRings™: swording from the “high position”.

5) Level five: Right leg forward high position as the ready position

6) Level six: Left leg forward high position as the ready position

7) Level seven: Alternating between right & left leg forward high positions as the ready position.

8) Level eight: Integrating high and center positions (going from center to low ready positions and vice-versa).

c. Lesson Plans for the Orange & Yellow SwordRings™: Swording™ from the “shoulder”

9) Level nine: Right leg forward shoulder position as the ready position

10) Level ten: Left leg forward shoulder position as the ready position

11) Level eleven: Alternating between right & left leg forward shoulder positions as the ready position.

12) Level twelve: Integrating shoulder and center positions (going from center to low ready positions and vice-versa).

d. Lesson Plans for the Green and Blue SwordRings™

13) Level thirteen: Integrating low and high positions

14) Level fourteen: Integrating low and shoulder positions

15) Level fifteen: Integrating shoulder and high positions

16) Level sixteen: Integrating positions.

e. Lesson Plans for the Violet SwordRings™

17) Level seventeen: Alternating between right & left knee down positions

18) Level eighteen: Alternating between sitting & kneeling positions

f. Lesson Plans for the White SwordRing™

19) Level nineteen: Alternating between sitting, kneeling, right & left knee down positions and transitioning from these into the standing position.

5. SwordWay™ Principles of Swording™ for Swordbearers™: multiple partner Swording™; swording with the short sword; the long and short sword; two long swords and miscellaneous skills.

Sword recovery

From the draw

a. Lesson Plans for Black & Gray SwordRings™: Swording™ from the “low position”.

1) Level one: Short sword Swording™, from the center position.

2) Level two: Short sword Swording™, from the low position.

3) Level three: Short sword Swording™, from the high position.

4) Level four: Short sword Swording™, from the shoulder position.

b. Lesson Plans for Dark Red & Red SwordRings™: swording from the “high position”.

5) Level five: Long sword Swording™ with 2 partners.

6) Level six: Long sword Swording™ with 3 or more partners.

7) Level seven: Short sword Swording™, with 2 partners.

8) Level eight: Short sword Swording™ with 3 or more partners.

c. Lesson Plans for the Orange & Yellow SwordRings™: Swording™ from the “shoulder”

9) Level nine: Short & Long Swording™; short sword in lead hand.

10) Level ten: Short & Long Swording™; long sword in lead hand.

11) Level eleven: Short & Long Swording™; short sword in lead hand with 2 partners.

12) Level twelve: Short & Long Swording™; long sword in lead hand with 2 partners.

d. Lesson Plans for the Green and Blue SwordRings™

13) Level thirteen: 2 Long swords with 1 partner.

14) Level fourteen: 2 Long swords with 2 partners.

15) Level fifteen: Short and Long swording with 3 or more partners.

16) Level sixteen: 2 Long swords with 3 or more partners.

e. Lesson Plans for the Violet SwordRings™

17) Level seventeen: the other side—long or short sword vs. 2 swords.

18) Level eighteen: Swording™ from “the draw”

f. Lesson Plans for the White SwordRing™

19) Level nineteen: sword recovery skills

G. SwordFit® SwordLife™ Curriculum

1. The SwordLife™ curriculum is broken down into two different areas:

a. The SwordLife™ Mission: explained to Sworder's™ parent(s)/guardian(s) on the PowerSwords™ handout (see FIG. 5) and assigned by the parent until Sworders™ reach the Swordbearer™ stage of the training when the SwordLife™ Mission becomes self-assigned.

1) The Mission is first submitted, either orally or in writing to the instructor who approves it for specificity, observability and focus.

a) For example “Showing more kindness” lacks three of these traits. “Showing more kindness to his sister” has focus: “Showing more kindness to his sister when she refuses to get out of his room” adds specificity to focus: Showing more kindness to his sister when she refuses to get out of his room by asking her nicely three times to leave and then getting mom or dad to take care of the situation” adds observability to specificity and focus.

2) Once approved the Sworder™ completes the mission, for a period of 7 days, to the satisfaction of the parent(s)/guardian(s) who then submit, either in writing or electronically, a statement to the instructor that the mission as completed.

3) Once the completion of the mission is conveyed to the instructor, the Sworder™ “unlocks” the PowerSword™ of her/his choice, and is given the corresponding PowerRing™ to put on his/her sword to use during the game portion of class.

4) The Sworder™ must continue to execute the mission that enabled her/him to unlock the PowerSword™ or the PowerRing™ will need to be confiscated either by the parent or the instructor.

5) If the Sworder™ possesses multiple PowerRings™ then missions must be executed and/or all PowerRings™ are lost. Lost PowerRings™ can be re-earned by completing respective missions for a period of 7 days. Thus, lost PowerRings™ do not have to be earned back one at a time, one week at a time, but may be earned back at once in a 7 day period, for example.

b. SwordLife Service™ is when a Sworder™ “serves the land” (her/his community) either through individual acts of service, as part of a group, or as an organizer/leader of a group performing an act of community service. In SwordFit® it has two stages of practice:

1) Individual service: a Sworder™ at the Practitioner or Swordarion™ stage of training must engage in, and document, individual acts of community service at least once every 4 months.

2) Organizing/leading service activities: a Sworder™ at the Swordbearer™ stage of training must organize and lead, either individually or as part of a group of Swordbearers™ collective acts of service at least once every 6 months.

H. SwordRealm™: the Fantasy Construct of the SwordFit® Curriculum

1. The SwordRealm™ curriculum has many purposes within the SwordFit® Exercise System™:

a. The first primary purpose of the SwordRealm™ is to directly support the main mission of SwordFit® to leverage fantasy elements used by video and computer games, films, television and print media (including, but not limited to graphic novels, novels, magazines, etc.) to increase the fitness of kids everywhere.

b. The second primary purpose of the SwordRealm™ is to provide a level of stimulus variation that will let it to successfully compete with video and computer games, films, television and print media for a child's attention.

1) The level of stimulus variation provided by fast-paced, stimulus-packed, and ever-evolving video and computer games, films, television and print media is what makes it very difficult for activities involving physical fitness to successfully compete with the hi-tech pastimes (already mentioned) for a child's continued attention.

c. The SwordRealm™ also serves many secondary, but important, functions:

1) The SwordRealm™ encourages fantasizing during SwordFit® classes.

2) The SwordRealm™ gives structure to Sworder's™ fantasies.

3) The SwordRealm™ encourages continued participation in SwordFit® as students gain powers and abilities to use in class as they progress through the construct.

4) The SwordRealm™ keeps SwordFit® training from getting boring by keeping the Sworders™ fantasy ever evolving.

5) The SwordRealm™, via unlocking PowerSwords™ through accomplishing SwordLife™ missions, leverages parental support of SwordFit® training

6) The SwordRealm™ is a marketing tool as Sworders™ share the SwordRealm™ (especially via the website) with friends, family and relatives.

7) The SwordRealm™ gives a positive direction to fantasies by leveraging it to teach important concepts in both Swording™ and life; and using it to supplant negative fantasies that may result from various other internal & external influences in a child's life.

2. The SwordRealm™ has many components that work the both independently and synergistically to accomplish both its primary and secondary purposes:

a. SwordRealm™ Component #1: SwordFit® music.

1) SwordFit® music plays a prominent role in every SwordFit® class:

a) Every SwordFit® class has a boom box off to the side that blasts out exciting music to elicit, reinforce and energize a child's fantasy role-playing during Swording™.

b) The boom box can be remotely controlled by the instructor

c) There is a SwordFit® CD for each Swording Cycle™

d) SwordFit® music selections are 60 seconds long, with a 5 second interval of silence between songs.

e) SwordFit® music literally determines when Swording™ occurs: when the music is playing the students are Swording™; then the music stops, Swording™ t also stops (this is part of the SwordFit® Code).

b. SwordRealm™ Component #2: levels.

1) The concept of having levels instead of ranks (as in the martial arts) is borrowed directly from the level concept used in many video, computer and other games and role-playing games.

2) “Leveling up”, which is the process that leads to, and includes, being awarded the SwordRings™ is a concept borrowed from many video, computer and other games and role-playing games.

3) These levels exist in for example in the three stages that form of the SwordFit® curriculum.

4) Within each Realm, going up in level increases the affect duration of a PowerSword™ by a factor of 10—this allows PowerSwords™ to continually evolve, remain fresh, and provide new stimulus variation.

(a) After touching a Sworder™ with a PowerSword™, the toucher holds up the number of fingers equal to how many times, times ten, that the touchee must endure the affects of the PowerSword™ (i.e., holding up 1 finger=10 times; 2 fingers=20 times, etc.).

c. SwordRealm™ Component #3: Realms.

1) The levels of training in the SwordFit® Exercise System™, across the stages, are grouped into Realms.

a) In each Realm, the powers of a PowerSword™ takes on different characteristics; this enables the PowerSword™ to evolve as the Sworders™ progress so that it remains exciting (provides stimulus variation).

(1) The different characteristics that PowerSwords™ take on in different Realms are still under development.

(a) Each of the Realms are named according to the “energy” the Sworder™ is most likely to experience while in that Realm for any given stage of his/her development as a Sworder™

b) The Primordial Realm™: Levels 1 to 4. As the name suggests, this is when the Sworder™ experiences the very beginning of whatever stage she/he is in.

(1) The Generative Realm™: Levels 5 to 8. As the name suggests, this is when the Sworder™ experiences the SwordWay™ Principals of Swording™, of whatever stage he/she is in, starting to generate an effect on her/his Swording™ experience.

(2) The Formative Realm: Levels 9 to 12. As the name suggests, this is when, as a result of the affect of the SwordWay™ Principals of Swording™ of whatever stage she/he is in, the Sworder™ starts to form a new way of Swording™ based on these principles.

(3) The Quickening Realm: Levels 13 to 16. As the name suggest, this is when, as a result of the affect of the SwordWay™ Principals of Swording™ of whatever stage he/she is in, the Sworder™ starts feel the “quickening” of excitement as the new principles are ever more successfully applied.

(4) The Higher Realm: Levels 17 to 19. As the name suggest, this is when, as a result of the affect of the SwordWay™ Principals of Swording™ of whatever stage she/he is in, the Sworder™ starts to become cognizant that the Principles of Swording™ that she/he has learned at this stage are a “higher” and superior (because they are more effective) way of Swording™

2) Each Realm has a “sphere” of influence at each stage of the SwordFit® curriculum and takes on a “sphere” name that is unique to the stage in which it appears.

d. SwordRealm™ Component #4: Spheres

1) Renaming the Realms as Spheres when they appear in each stage serves two purposes:

a) Renaming Realms as Spheres provides stimulus variation as students move from stage to stage—so they don't just get “the same old Realm” repeated at the next stage.

b) Renaming Realms as Spheres represents how the stage itself specifically influences how the “energy” experienced by each Sworder™ in that Realm is felt.

2) The name of the Sphere represents the specific energy of that the Realm takes on in that stage.

a) The Spheres of the Primordial Realm

(1) The Primordial Realm is known as the “Sphere of Darkness” in the student stage, because the Sworder™ is “in the dark” and has little if any knowledge of Swording™.

(2) The Primordial Realm is known as the “Practice Sphere” in the practitioner stage, because the Sworder™ is just beginning to “practice” the Swording™ principles that were learned as a student.

(3) The Primordial Realm is known as the “Sphere of the self” in the Swordbearer™ stage, because the Sworder™ should be aware of a feeling of “self” or “ego” from having reached such a high Swording™ status and from having gained such Swording™ skill.

b) The Spheres of the Generative Realm

(1) The Generative Realm is known as the “Sphere of Heat” in the student stage, because the Sworder™ should have completely shed the initial awkwardness that comes from starting something new and should start to begin feeling the “heat” of confidence in Swording™.

(2) The Generative Realm is known as the “Reflection Sphere” in the practitioner stage, because the Sworder™ should be starting to reflect on how her/his practice of the Principles of Swording™ learned at the student level are working better than not practicing them.

(3) The Generative Realm is known as the “Sphere of the Struggle” in the Swordbearer™ stage, because the Sworder™ should be realizing that the inflated sense of self/ego that comes from being at such a high level of Swording™ must be balanced by humility—but that establishing this balance is a struggle because having a “big ego” can be a good and safe feeling.

c) The Spheres of the Formative Realm

(1) The Formative Realm is known as the “Sphere of the Sun” in the student stage, because the Sworder™ confidence is letting her/him try new things and she/he is “seeing the light (of the Sun)” because she/he is starting to go beyond the techniques and understand the underlying strategy.

(2) The Formative Realm is known as the “Open Sphere” in the practitioner stage, because, after reflection (and experiencing the supreme usefulness of the Principles of Swording™, the Sworder™ is open to learning and completely absorbing everything.

(3) The Formative Realm is known as the “Sphere of the Path” in the Swordbearer™ stage, because the Sworder™ is now understanding that the struggle against the self/ego is the path, and the road to mastery.

d) The Spheres of the Quickening Realm

(1) The Quickening Realm is known as the “Sphere of the Life” in the student stage, because, now that the Sworder™ has seen the light (of the Sun Sphere) a new life is instilled in her/his swording as it comes alive with the application of the newly realized strategies that form the bridges between mere technique.

(2) The Quickening Realm is known as the “Clear Sphere” in the practitioner stage, because, after reflection (and experiencing the supreme usefulness of the Principles of Swording™, the Sworder™ is gaining clarity on how practice should, and should not, be.

(3) The Quickening Realm is known as the “Sphere of the Light” in the Swordbearer™ stage, because the Sworder™ is beginning to see the Light of the higher Self as mastery over the lower self/ego begins to dawn.

e) The Spheres of the Higher Realm

(1) The Higher Realm is known as the “Sphere of the Knowledge” in the student stage, because, the Sworder™ is completing the physical aspect of the Principles of Swording™ and thus the “Knowledge” component is being completed as the time for practice approaches.

(2) The Higher Realm is known as the “Introspection Sphere” in the practitioner stage because, the Sworder™ is coming to realize that maintaining clarity and success in practice is dependent on her/his inner state, which begins to be explored through introspection—a necessary foundation for beginning the road to mastery that will begin in the Swordbearer™ stage.

(3) The Higher Realm is known as the “Sphere of the Gate” in the Swordbearer™ stage, because as the Sworder™ gains stability in the higher Self, creativity begins to issue forth as if a gate has been opened; and, to walk into that creativity as the higher Self is to enter the realm of art and mastery and begin the journey of Swording™ as a Swordingmaster™—which is a journey of subtleties and realizations that no curriculum can contain.

e. SwordRealm™ Component #4: The PowerSwords™

1) PowerSwords™ both in concept and application are a fantasy construct, since the PowerSword™ powers are “just pretend” and are only activated by rules during the Swordario™ portion of the SwordFit® class.

2) PowerSwords™ gain power as a Sworder™ moves through the levels (see levels, above).

3) PowerSwords™ gain abilities as a Sworder™ moves from one sphere to the next

a) The basic abilities of the various PowerSwords™ can be found on the PowerSword™ handout (see FIG. 5).

(1) More advanced PowerSword™ abilities, as stated previously, are still under development.

f. SwordRealm™ Component #5: The Fantasy Persona

1) The Fantasy Persona component of the SwordRealm™ is a construct that mimics the natural play tendencies of children.

a) Children often imagine themselves to be someone else when they play. SwordFit® intentionally uses this natural tendency as part of its construct to create the image in the child's mind of SwordFit® being a game (which it is, in part). This makes participating in the SwordFit® Exercise System™ more fun!

2) The Fantasy Persona component of the SwordRealm™ leverages video/computer and role-playing game investment strategies.

a) “Picking a character” when playing video/computer and role-playing games is a familiar stage in the playing process of hi-tech pastimes for most kids and is a well known strategy to deepen a child's emotional and fantasy “investment” in the game experience.

3) The Fantasy Persona component of the SwordRealm™ has specific characteristics at each level, and in each stage, that are manifested both in the class itself, and will also appear on the SwordFit® website as much as possible (even when not specifically mentioned as such, below).

a) Student Stage Fantasy Persona characteristics and manifestations: creating a SwordRealm™ Character Identity.

(1) Level One Fantasy Persona: Name & photo appear on the website as a Sworder™ who has entered the SwordRealm™

(2) Level Two Fantasy Persona: SwordFit® Name: the Sworder™ chooses a SwordFit® name that he/she will be known by, and addressed as, from then on. This name is written with black permanent marker on a 4″ strip of silver duct tape placed on the center of the helmet just above the face cage; it also appears on the website.

(3) Level Three Fantasy Persona: SwordingClan™: the Sworder™ chooses a SwordingClan™ that he/she will belong to. There are four different clans, each one bestows a different title that is used as a prefix “Title” that is placed before the Sworder's™ name and is used both in class and on the website:

(a) The RebelClan™ is chosen by a student if they feel they are a Sworder™ who likes making up their own moves. Members of this clan have the title Count or Countess placed before their SwordFit® name. A square piece of silver duct tape is also placed on each side of the helmet's name plate and is marked with an “X”—the ClanMark™ of the rebel clan.

(b) The GuildClan™ is chosen by a student if they feel they are a Sworder™ who wants to study hard and master the moves of Swording™. Members of this clan have the title Lord or Lady placed before their SwordFit® name. A square piece of silver duct tape is also placed on each side of the helmet's name plate and is marked with an “t” (representing a sword)—the ClanMark™ of the Guild clan.

(c) The WarriorClan™ is chosen by a student if they feel they are a Sworder™ who likes to be aggressive and move forward in an attempt to touch their partner and make her/him bow. Members of this clan have the title of General placed before their SwordFit® name. A square piece of silver duct tape is also placed on each side of the helmet's name plate and is marked with an “ ” pointing upward (the arrow represents forward motion, which is aggressiveness)—the ClanMark™ of the warrior clan.

(d) The DefenderClan™ is chosen by a student if they feel they are a Sworder™ who likes to let their partner try to touch them first, and then block or move out of the way before trying to make a touch of their own. Members of this clan have the title Commander placed before their SwordFit® name. A square piece of silver duct tape is also placed on each side of the helmet's name plate and is marked with an “O” (representing a shield, the symbol of defense)—the ClanMark™ of the rebel clan.

(4) Level Four Fantasy Persona: The Powersign™. The Sworder™ creates a sign or symbol for her/him self. The Powersign™ is unique to each Sworder™ within any local chapter (e.g., no two Sworders™ within the same chapter can have the same Powersign™). The Powersign™ must include somewhere within it the ClanMark™ that the Sworder™ belongs to. The Sworder's™ Powersign™ also appears on the website.

(5) Level Five Fantasy Persona: Special Opening bow. The Sworder™ creates a special opening bow to be used whenever he/she bows to their partner at the beginning of a section of the SwordFit® class. The bow can take any form, but must incorporate the Handsign™ of their clan.

(a) The RebelClan™ Handsign™ is crossing at least two fingers of at least one of the hands.

(b) The GuildClan™ Handsign™ is holding one of the hands flatly open with the fingers and thumbs together so that the hand forms a “blade” shape that is representative of the sword.

(c) The WarriorClan™ Handsign™ is to point an index finger at the partner during some point of the bow.

(d) The DefenderClan™ Handsign™ is placing the tip of at least one of the fingers on one of the hands so that it touches the tip of the thumb to form a circle.

(6) Level Six Fantasy Persona: Special Sword Draw. The Sworder™ creates a special way of drawing the sword: bringing the sword from its “away” position at her/his side, to the center ready position that is assumed before a bout begins. The special draw should not take longer than three seconds.

(7) Level Seven Fantasy Persona: Special Closing bow. The Sworder™ creates a special closing bow to be used whenever he/she bows to their partner at the end of a section of the SwordFit® class. The bow should be different, in any way, from the opening bow—and, again, must incorporate the Handsign™ of whichever clan the Sworder™ belongs to.

(8) Level Eight Fantasy Persona: Special Sword-Away. The Sworder™ creates a special way of returning the sword: bringing the sword from its ready position to its “away” position at her/his side. The special sword-away should not take longer than three seconds.

(9) Level Nine Fantasy Persona: Special Touched-bow: The Sworder™ creates a special bow to be used whenever he/she bows is touched by their partner's sword. This bow must be different in some way from either the closing or opening bows; but, unlike them, should not, incorporate the Handsign™ of whichever clan the Sworder™ belongs to.

(10) Level Ten Fantasy Persona: Special Victory Stance. The Sworder™ creates a special stance (body & sword position) to be assumed whenever he/she touches her/his partner causing him/her to bow. The stance must incorporate the Handsign™ of whichever clan the Sworder™ belongs to.

(11) Level Eleven Fantasy Persona: yet to be developed.

(12) Level Twelve Fantasy Persona: yet to be developed.

(13) Level Thirteen Fantasy Persona: yet to be developed.

(14) Level Fourteen Fantasy Persona: yet to be developed.

(15) Level Fifteen Fantasy Persona: yet to be developed.

(16) Level Sixteen Fantasy Persona: yet to be developed.

(17) Level Seventeen Fantasy Persona: yet to be developed.

(18) Level Eighteen Fantasy Persona: yet to be developed.

(19) Level Nineteen Fantasy Persona: yet to be developed.

b) Practitioner Stage Fantasy Persona: Creating a SwordRealm™ Swording™ Identity.

(1) Level One Fantasy Persona: Special Touching Method™ #1. The Sworder™ will create her/his own Touching Method™: a touching strategy that must start from the center ready position and may include one or more touching combinations—but must not exceed 3 movements intending to either touch or feint.

(2) Level Two Fantasy Persona: Special Touching Method™ #1 Stance. The Sworder™ will create her/his own “stance” from which to begin his/her special Touching Method™ #1.

(3) Level Three Fantasy Persona: Special Touching Method™ #1 Name. The Sworder™ will create her/his own name for her/his Touching Method™ #1, which will be yelled out after assuming that Touching Method's™ special stance.

(4) Level Four Fantasy Persona: Special Touching Method™ #1 Victory Bow. The Sworder™ will create her/his own bow for her/his Touching Method™ #1, which will be used whenever the special Touching Method™ results in a touch on his/her partner.

(5) Level Five Fantasy Persona: Special Touching Method™ #2. The Sworder™ will create her/his own Touching Method™: a touching strategy that must start from the center ready position and may include one or more touching combinations—but must not exceed 3 movements intending to either touch or feint.

(6) Level Six Fantasy Persona: Special Touching Method™ #2 Stance. The Sworder™ will create her/his own “stance” from which to begin his/her special Touching Method™ #1.

(7) Level Seven Fantasy Persona: Special Touching Method™ #2 Name. The Sworder™ will create her/his own name for her/his Touching Method™ #1, which will be yelled out after assuming that Touching Method's™ special stance.

(8) Level Eight Fantasy Persona: Special Touching Method™ #2 Victory Bow. The Sworder™ will create her/his own bow for her/his Touching Method™ #1, which will be used whenever the special Touching Method™ results in a touch on his/her partner.

(9) Level Nine Fantasy Persona: Special Touching Method™ #3. The Sworder™ will create her/his own Touching Method™: a touching strategy that must start from the center ready position and may include one or more touching combinations—but must not exceed 3 movements intending to either touch or feint

(10) Level Ten Fantasy Persona: Special Touching Method™ #3 Stance. The Sworder™ will create her/his own “stance” from which to begin his/her special Touching Method™ #1.

(11) Level Eleven Fantasy Persona: Special Touching Method™ #3 Name. The Sworder™ will create her/his own name for her/his Touching Method™ #1, which will be yelled out after assuming that Touching Method's™ special stance.

(12) Level Twelve Fantasy Persona: Special Touching Method™ #3 Victory Bow. The Sworder™ will create her/his own bow for her/his Touching Method™ #1, which will be used whenever the special Touching Method™ results in a touch on his/her partner.

(13) Level Thirteen Fantasy Persona: Special Touching Method™ #4. The Sworder™ will create her/his own Touching Method™: a touching strategy that must start from the center ready position and may include one or more touching combinations—but must not exceed 3 movements intending to either touch or feint.

(14) Level Fourteen Fantasy Persona: Special Touching Method™ #4 Stance. The Sworder™ will create her/his own “stance” from which to begin his/her special Touching Method™ #1.

(15) Level Fifteen Fantasy Persona: Special Touching Method™ #4 Name. The Sworder™ will create her/his own name for her/his Touching Method™ #1, which will be yelled out after assuming that Touching Method's™ special stance.

(16) Level Sixteen Fantasy Persona: Special Touching Method™ #4 Victory Bow. The Sworder™ will create her/his own bow for her/his Touching Method™ #1, which will be used whenever the special Touching Method™ results in a touch on his/her partner.

(17) Level Seventeen Fantasy Persona: Special Defensive Strategy #1: The Sworder™ will record her/his own defensive strategy method: the strategy may be a realization on how to use defensive strategies he/she has already been taught (in which case the strategies name contains the designation “Realization”); or, the strategy may be an original invention. This strategy is named by the Sworder's™ and posted on her/his webpage on the SwordFit® website. The prerequisite for the strategy is that it MUST have experienced success during actual Swording™, e.g., it cannot just be a theoretical construct, but must be a proven application.

(18) Level Eighteen Fantasy Persona: Special Defensive Strategy #2: Same parameters as per Special Defensive Strategy #1 in 17), above.

(19) Level Nineteen Fantasy Persona: Special Defensive Strategy #3: Same parameters as per Special Defensive Strategy #1 in 17), above.

c) Swordbearer™ Stage Fantasy Persona: Creating a SwordRealm™ Swording™ Identity for the SwordRealm™ Character.

(1-18) Levels One through Eighteen: Under Development

g. SwordRealm™ Component #6: The SwordFit® Knight (hereafter “Knight”).

1) A Knight will be designated by small strips of black duct tape on the outside edges of the plastic face cage at the 12, 3, 6 & 9 o'clock location; and, by a larger square of black duct tape on the sides and back of the helmet.

2) The Knight Construct leverages the concept of the Jedi Knight from the Star Wars Saga to add excitement and stimulus variation to the SwordRealm™

3) A Knight has special powers in the Swordario™:

a) A Knight has the ability to use 2 PowerRings™ on his/her sword at the same time.

(1) When the 2 PowerRings™ are touching powers (affecting a partner after being touched), the Knight might indicate which PowerSword™ power was activated by the touch by pointing at it until the partner nods her/his head in understanding.

(2) When the 2 PowerRings™ are defensive powers, or if one ring is defensive and the other is a touching power, both, powers are active simultaneously.

b) A Knight has the ability to “use the force” and take a PowerRing™ from a Sworder™ who is not a Knight when the Knight “touches the Sworder™ out” during a Swordario™ (note: a Knight cannot take a PowerRings™ from another Knight).

c) Other Knight powers are currently in development.

4) The Fantasy Construct of the SwordFit® Knight serves multiple purposes:

a) The SwordFit® Knight is a peer-mentoring program: a Sworder™ gives a referral card to a friend. If the friend enrolls in the program, she/he becomes an “apprentice”; the referring Sworder™ becomes a SwordFit® Knight—for as long as the apprentice continues regular training in SwordFit® The Knight has the following responsibilities to the apprentice:

(1) The Knight has the responsibility to guide and help his/her apprentice through the various aspects of the SwordFit® Exercise System™

(a) The Knight has the responsibility to keep from the apprentice any and the information of the SwordFit® Exercise System™ that is above the apprentice's level at the time (that is not already available to the apprentice through the website.

(2) The Knight has the responsibility to protect her/his apprentice, if possible, during the Swordario™

b) The SwordFit® Knight program serves to refer more kids into the local SwordFit® chapter.

c) The SwordFit® Knight program begins to develop responsibility, confidence and leadership in those who become Knights.

h. SwordRealm™ Component #7: the SwordFit® Website.

1) The SwordFit® Website is constantly under development and evolution, but will represent and reinforce the SwordRealm™ in every way possible, thus leveraging the other aspects of the SwordRealm™ already mentioned.

I. Facilities for Delivering the SwordFit® Curriculum

1. Ultimately, facilities for delivering the SwordFit® curriculum are determined by availability and cost. The final decision for securing a facility/facilities for delivering the SwordFit® curriculum is decided by the local chapter's Swordsei™ & Administrator.

2. Ideally, local chapters should use SwordFit's® non-profit, youth organization status to obtain use of public school facilities after hours for little or no cost.

3. Local chapters may also rent space from a variety of sources, including, but not limited to:

a. Housing community clubhouses/gyms.

b. Social club spaces from the Elks, Rotary Club, Masons and other such societies and clubs.

c. Unused space hours from dance, gymnastics and similar schools.

d. Churches, town halls, recreational centers, community centers, firehouses and similar institutions that have large open spaces that are not used full-time.

e. Privately owned health clubs, schools, spas, gyms and similar spaces.

4. Local chapters should avoid renting certain facilities:

a. Martial arts school facilities.

b. An entire building/store front exclusively for SwordFit®

1) Local chapters should keep overhead low to be able to offer classes for local children at a low price and to be able to pay Swordsei™ & Administrators as much as possible.

2) Local chapters should operate a very “lean” business that is capable of sustaining a revenue margin (after expenses) that will enable the chapter to remain open even if student enrollment drops (i.e. due to economic shifts). This necessitates a low overhead profile for any local chapter.

c. Partnerships with recreational departments, schools, and other such organizations which, as they expire, can “feed” new students into the regular programs.

5. Local chapters should avoid long-term leases (over 6 months) because they don't allow a chapter to move classes to another location to either increase or decrease facility cost; or, increase or decrease class space size.

6. Processes whereby Local chapters partner with recreational departments, schools, and other such organizations which insist on collecting money directly from students and then paying the Swordsei™ are still under development, since currently the tuition for every local chapter is preferably to be collected by the tuition collection company currently being used by SwordFit®.

7. Music clearance must be obtained: proper delivery of the SwordFit® curriculum is dependent upon the Sworders™ being able to hear the SwordFit® “music”, so the local chapter must make sure this will not disturb any other activities in the facility.

J. Class Scheduling for the SwordFit® Curriculum

1. There is no limit to the number of classes a local chapter may offer, however, care should be taken to grow slowly so that the chapter does not overextend itself; and,

2. Each SwordFit® Chapter should ideally provide at least 2 days of training for each time offering (since exercising at least twice a week is generally considered most beneficial).

a. Ultimately, day and time offerings of the class are determined by the two factors of facility availability and the structure of the local populations day.

b. Ideally, the two days should be one day apart, i.e., Mon. & Wed. or Tue. & Thurs.

1) The weekends, beginning with Friday, should usually be avoided.

2) One day of training may be initially be provided for each time offering, if necessary, to lover the initial overhead, but in considering this option, it should be remembered that this will also lower the potential revenue generated (students can only select the 1×/week tuition of $69.95, instead of the 2×/week tuition of $89).

3) One day of training may also be provided due to lack of facility availability.

4) One day of training may also be provided for a specific time offering if, over a period of time, a class time on a certain day maintains a very low student enrollment.

c. A “time offering” is the time the class is to be held, i.e., a 4 pm class; or, a 6:45 pm class.

1) Ideally, time offerings are the same time on two different days.

2) Time offerings may be slightly skewed to accommodate facility availability.

a) Time offerings are determined by the following factors:

(1) The time when a majority of elementary school children in the chapter's local area arrive home.

(2) The time for a majority of middle school children in the chapter's local area arrive home.

(3) The time a majority of parents return home from a day's work.

(4) If a majority of elementary school children are home by 3:30 pm, then

b) Skewed times may be considered the same “time offering” as long as the two time will generally accommodate a majority of the students enrolled in it.

(1) For example a 6:45 pm Mon. & a 6:30 pm Wed. could be considered offering 2 days of training for a single time offering for the children of parents who get off of work between 5 & 6 pm, since both times could accommodate these children.

(2) In contrast to (1), above, a 6:45 pm Mon. & a 4:00 pm Wed would not be considered a single time offering for the children of parents who get off of work between 5 & 6 pm.

K. SwordFit® Class Outline for the SwordFit® Curriculum

1. A SwordFit® Class is macromanaged by the clock; it is micromanaged by music.

a. The clock determines the approximate time each class section begins.

b. The music determines the length of the bout and the pace of each section of the class.

1) Each bout, except in the cases of an emergency that draws the Swordsei's™ attention completely away from supervising the class, begins when the music begins and ends when the music ends.

a) The Swordsei™ should strictly avoid “pausing” the music in the middle of a bout (except during the Swordario™, when this may be necessary to go clarify rules, etc.

2. The Swordsei™ will deliver two different class outlines: a standard class outline, and one for the LevelUp week.

a. The Standard Class Outline:

1) 0-10 minutes: FreeBout™

a) Note: the instructor should start the class precisely on time—even if no students are present when the music begins.

b) Line-up: Swordsei™ verbally and visually instructs the Sworders™ to line up on the floor as indicated, with the command of “Marks!”.

c) Meditation: the first track on the SwordFit® CD.

d) Bow: Swordsei™ verbally and visually instructs the Sworders™ to bow to their partners with the command “Bow!”

e) Swords: Swordsei™ verbally and visually instructs the Sworders™ to “draw” their swords with the command: “Swords!”

f) FreeBouts™: Swordsei™ gives SwordWay™ lessons and good effort bands to individual students.

g) Line-up: Swordsei™ pauses music between selections and verbally and visually instructs the Sworders™ to return to their starting lineup position with their partner with the command: “Marks!”

h) Bow: Swordsei™ verbally and visually instructs the Sworders™ to bow to their partners with the command “Bow!”

2) 10-20 minutes: PowerUp™

a) Sitting: Swordsei™ verbally & visually instructs the Sworders™ sit in a “U” with the instructor at the open end with the command “Helmets off and have a seat!”

(1) Sworders™ should be seated so that the open end of the “U” is facing a “dead zone” were there is no, or the least amount of, activity; if there is activity occurring behind the instructor, the Sworders™ will be distracted.

b) Encouragement: Swordsei™ will verbally and visually explain/demonstrate the PowerUp™ exercise and how the Sworders™ will perform it (Peer encouragement may be used with/instead of a demonstration by the Swordsei™ if any Sworders™ are present who can demonstrate the exercise).

c) PowerUp™ Bouts: Swordsei™ gives SwordWay™ lessons and good effort bands to individual students. Music is paused as previously explained in Section III, D, f, above, concerning the delivery of the supplemental strengthening aspect of the Physical SwordFit® curriculum.

d) Peer encouragement: Swordsei™ pauses the music and visually & verbally instructs everyone to sit where they are with the command, “Helmets off and be seated!” One pair is asked to stand and one or both are asked to demonstrate the SwordSkill™. Swordsei™ encourages by verbally and visually pointing out the positive parts of the demonstration (none of the negative!). Swordsei™ finishes with the question: “Can you try to do it this way when you stand up to continue practicing this SwordSkill™?” (for example, all must reply “Yes, Swordsei™ !”).

e) SwordSkills™ bout continued.

f) Line-up: as per previous.

g) Bow: as per previous.

(4) 20-25 minutes: SwordWay™ Philosophy & Break a) Sitting: as per previous.

b) SwordWay™ Philosophy: as per Sections III, E, 4, above, concerning the delivery of the SwordWay™ Philosophical curriculum.

c) Break: Sworderi™ leave their gear where they sit and go get a drink and use the restroom if necessary.

3) 25-30 minutes: SwordSkills™

a) Sitting: as per previous.

b) Encouragement: Swordsei™ will verbally and visually explain/demonstrate the SwordSkills™ and how the Sworders™ will perform it with a partner once the encouragement is over.

c) SwordSkills™ bout: Swordsei™ starts the music and encourages proper SwordSkills™ performance.

d) Peer encouragement: Swordsei™ pauses the music and visually & verbally instructs everyone to sit where they are with the command, “Helmets off and be seated!” One pair is asked to stand and one or both are asked to demonstrate the SwordSkill™. Swordsei™ encourages by verbally and visually pointing out the positive parts of the demonstration (none of the negative!). Swordsei™ finishes with the question: “Can you try to do it this way when you stand up to continue practicing this SwordSkill™?” (for example, all must reply “Yes, Swordsei™ !”).

f) Line-up: as per previous.

e) Bow: as per previous.

(5) 30-45 minutes: Swordario™

a) Sitting: as per previous.

b) Swordario™ Explanation: Swordsei™ explains the Swordario™

c) PowerSword™ Recognition: Swordsei™ asks Sworders™ with PowerSword™ to hold them up. For each PowerSword™ Swordsei™ briefly explains what happens it a Sworders™ is touched.

d) Swording Code™ Reminder: Swordsei™ reminds the students that the Swording Code™ is still to be followed.

e) Additional Swordario™ Rules Reminder (as applicable): 1) place your sword behind your back if you are out and returning to base; 2) any other that applies.

f) Swordario™: music plays and Swording Code™ applies.

g) Finish: SwordFit® and High-fives—Students gather in a circle with swords in the center and the Swordsei™ says, “Everyone raise your swords and yell SwordFit® on the count of three! One, two, three: SwordFit®!”

b. The LevelUp Outline:

1) 0-15 minutes: FreeBout™—as per Standard outline, above: instructor places LevelUp markers on Sworder's™ helmets.

2) 15-25 minutes: PowerUp™—as per Section III, D, f, above, concerning the delivery of the supplemental strengthening aspect of the Physical SwordFit® curriculum during the LevelUp week.

3) 25-30 minutes: SwordWay™ Philosophy & Break: as per Sections III, E, 4, above, concerning the delivery of the SwordWay™ Philosophical curriculum.

4) Swordario™: as per standard except that the Sworders™ form a line to do Swording™ with the instructor as follows:

a) One at a time until the Sworders™ have gone at least once (for shorter lines this may be repeated); then,

b) Two at a time; then

c) Three at a time; then

d) Four at a time; then

e) Everyone at once.

IV. Extracurricular SwordFit® Activities.

A. Regional, national and international service projects

1. Logistics and details are still under development.

B. SwordFit® Competitions.

1. Though SwordFit® classes are absolutely non-competitive, SwordFit® may hold competitions at the local, regional, national and international levels for those Sworders™ who wish to test their skills.

2. Competition rules, structure, costs and other logistics are still under development.

C. SwordFit® Camps

1. SwordFit® Camps (both day and overnight) may be held at the local, regional, national and international level.

2. Camp structure, costs and other logistics are still under development.

D. SwordRealm™ Quest™

1) SwordFit® Quests™ are where Sworders™ come together in local parks (or other such area) to play giant Swordarios™ usually followed by, or concurrent with a picnic and other activities for the Sworder™ and her/his family.

2) SwordFit® Quests™ may also be held at the regional, national and international level.

3) SwordFit® Quests™ structure, costs and other logistics are still under development.

V. Administrative/Financial

E. International Administration/Financial: SwordFit® International™

2. Administration for SwordFit® at the international level is handled as described in Section I, A, 4, d, above.

3. The Council of Administrators directs funds needed to operate SwordFit® International to it from a percentage they have fixed of the monies collected from local chapters at the at each national level.

4. The Council of Administrators, together with the Council of Masters, may hold international SwordFit® competitions for the benefit of the students and to collect revenue (the retained earnings from which, must be distributed to impoverished SwordFit® chapters worldwide.

a. Rules, fees and other particulars of international SwordFit® competition are still under development.

F. National Administration/Financial: SwordFit® [Name of Nation]

1. Administration for SwordFit® at the international level is handled as described in Section I, A, 3, b, above.

2. National Administrators directs funds needed to operate SwordFit® at a national level to it from a percentage they have fixed of the monies collected from local chapters at the national level.

3. SwordFit® at the national level may hold national SwordFit® competitions for the benefit of the students and to collect revenue (the retained earnings of which, must be distributed to International Administrators to subsidize competitions for impoverished nations or regions).

G. Regional Administration: [SwordFit's® designation of region] SwordFit®.

1. Administration for SwordFit® at the international level is handled as described in Section I, A, 2, b, above.

2. Regional Administrators solicits funds needed to operate SwordFit® at a regional level to it from the monies collected by each local chapters.

3. SwordFit® at the regional level may hold regional SwordFit® competitions for the benefit of the students and to collect revenue for the region (though a percentage, to be determined at the international level, must be remitted to the same).

H. Local Chapter Administration/Financial: SwordFit® of [Name of town/city or locale]

1. Administration for Local Chapters is handled as described in Section I. A. b, on local chapter Administrative Personnel above.

a. In many ways, the Chapter Administrator (s) and Chapter Instructor (s) (who may be the same individual) run each local chapter like a business that is independently owned.

1) The size, growth and maintenance of each local chapter is the sole responsibility of the local chapter.

2) As long as it complies with national SwordFit® administrative guidelines, it can be structured any way.

3) SwordFit® at the national level acts like a tuition billing company that collects tuition and then disburses it to the local chapter, less a small percentage.

2. Local Chapter Financial

a. In many ways, the Chapter Administrator (s) and Chapter Instructor (s) (who may be the same individual) run each local chapter's finances like a business that is independently owned.

5) SwordFit® at the national level acts like a tuition billing company that collects tuition and then disburses it to the local chapter, less a small percentage.

6) As long as it complies with national SwordFit® administrative guidelines, it can be structured any way.

7) However, just like SwordFit® at the national level is financially transparent to the local level (see V, D, d, b) (1) (b) and V, D, b, (1), below); it is preferably that SwordFit® local chapters be transparent to the national level.

a) Local chapter bank accounts and accounting records must be available online to the National Administrator.

b. Local Chapter Sworder™ Tuition Collection

1) Preferably, Local Chapter tuition is collected at the National Level.

a) Local Chapter tuition is deposited into a National SwordFit® bank account that is both obtained and maintained by SwordFit® at the National level.

(1) Enrollment agreements are between the Sworders™ parent/legal guardian and SwordFit® at the national level; and not, between the Sworders™ and the local chapter.

(a) This prevents local chapters from selling enrollment agreements to third parties; and/or, from selling local chapters to third parties without consent at the national level.

(2) A percentage (exact percent has yet to be determined) of monies collected (less collection fee) is retained by SwordFit® at the National level.

(a) This percentage of monies collected (less collection fee) is withdrawn and deposited into the bank account designated for the administration of SwordFit® at the National Level—said withdrawals will occur simultaneous with the disbursement of the Local Chapter's percentage (less collection fee—by the tuition billing company; SwordFit® charges no fee) to a bank account of said Local Chapter that is owned, controlled and maintained by same.

(b) National transparency: Local chapter administrators can have online viewing access for the National SwordFit® bank account through which their monies flow; as well as access to the SwordFit® accounting records for the nation in which they reside (which will be maintained online)—with the exception of collection and disbursement records for local chapters other than their own.

b) Local Chapter tuition is collected by a single source. For example, all month-by-month tuition for SwordFit® training is collected by a single, SwordFit® authorized, tuition billing company via automatic debiting of checking, savings or credit cards and placed into a holding account maintained by said company for each local chapter.

(1) Tuition collection transparency: each local chapter ad will have complete online access to these accounts as per normal access granted by said billing company—exclusive of the ability to alter collection and dispersion destination accounts or methods of collection.

c) No monthly tuition is to be collected by the local chapter: absolutely NO local chapters, under any circumstances whatsoever, are authorized to collect monthly tuition.

(1) Failure to follow this mandate will result in immediate revocation of the Chapter's charter letter giving it permission to operate.

d) 6 month prepaid tuition in the form of a single check may be collected by the local chapter; BUT must be made pay to the order of SwordFit® [name of nation] and must be mailed directly to SwordFit® at the national level (which then disburses the same amount back to the local chapter).

(1) Failure to follow this mandate will result in a written warning. The 3rd violation will result in immediate revocation of the Chapter's charter letter giving it permission to operate.

(2) 6 month prepaid tuition is the lowest and highest amount on non-monthly prepaid tuition than can be collected at the local level.

2) Local Chapter Enrollment fees are processed at the local level.

a) Enrollment fees are made either in the form of cash or check and are payable to the local SwordFit® chapter.

(1) The National Administrator, under any circumstances, cannot process enrollment fees. Any enrollment fees received at the national level in the forms of checks and money orders will be destroyed; cash will be confiscated. No reimbursement or restitution will be made to the local chapter from which such fees originated. It will be the sole responsibility of the local chapter to take full responsibility for the incident (clearly absolving SwordFit® at the national level, without prejudice) and to reimburse the client for any loss.

c. The local chapter is solely responsible for chapter expenses such as chapter and student gear, facility rent, local marketing, etc.

d. Tuition Rates are set at the local level but audited at the regional and national levels (and therefore subject to mandatory change by regional and/or national administrators).

1) Tuition should be set within 10% of the tuition for recreational programs offered by the community's parks and recreation department (where they exist).

2) Tuition should be perceived by the community at large as being very reasonably priced; and significantly lower in price than similar programs offered by profit organizations (i.e., martial arts schools, gymnastic centers, horseback riding lessons, music lessons, etc.)

3) Where possible, and in line with 1) & 2), above, tuition should be within 10% of the national average for SwordFit® classes offered by other chapters.

a) Currently at $69.95 for once a week classes, and $89 for unlimited classes per week.

e. SwordFit® training cannot be refused to any potential Sworder™ due to an inability to pay tuition.

1) Each individual chapter must make arrangements to cover the cost of gear for such students (who may be able to pay some of it themselves); though funds can be applied for from the national or international SwordFit® levels.

f. Enrollment fees are set at the local level but audited at the regional and national levels (and therefore subject to mandatory change by regional and/or national administrators).

1) Student enrollment fees should be the wholesale cost of the a single Red, 40″ Actionflex sword and the Red, Ronin helmet plus shipping and handling—on the supplier's end—plus a modest (no more than $5) enrollment administration fee by the local chapter; or the equivalent of the monthly tuition fee for unlimited training, whichever is greater.

a) Above mentioned SwordFit® student gear will be available to the local chapter directly from the distributor (currently available from Century Martial Arts)—each chapter will have access to SwordFit's® national wholesale account with this supplier (or whichever other supplier can supply this identical gear)

b) The SwordFit® Regional Administrator; or several local SwordFit® chapters may get together to bulk order gear (and thus cut costs and increase enrollment revenue).

g. Local chapters may hold competitions once the total number of Sworders™ in the immediate area (may include nearby chapters) reach 100. The local chapter may retain revenues earned, less a small percent paid to the International Administrator for redistribution to impoverished SwordFit® chapter competitions or tuition/gear subsidies.

VI. Sale of Local Chapters

A. There is no objection to the sale of local chapter, as long as the following guidelines are maintained:

1. A local chapter who loses their charter letter forfeits the right to sell the chapter; instead, it becomes the property of SwordFit® at the national level, who may then sell the chapter to a qualified party.

2. The buyer must have complete access to the same online banking and accounting information that is available to National.

3. The buyer must agree to operate the chapter in accordance with the provisions of the charter letter.

VII. Local Chapter Dissolution.

A. A local chapter cannot disband, dissolve or otherwise cease to operate without notifying SwordFit® at the National level (or international level if no national level yet exists).

1. This provision give SwordFit® a chance to maintain its services to the children of the local chapter by finding another instructor and/or administrator to take over the chapter.

2. There will be stiff financial penalties and legal action for dissolving a chapter without following this procedure.

While the preferred embodiment of the invention has been illustrated and described, as noted above, many changes can be made without departing from the spirit and scope of the invention. Accordingly, the scope of the invention is not limited by the disclosure of the preferred embodiment.

The embodiments of the invention in which an exclusive property or privilege is claimed are defined as follows:

1. A method comprising:
providing one or more players with a flexible sword-like device;
providing a structured sword-training regime having a plurality of skill levels wherein one or more of each skill level corresponds to a rank and where players engage in sparring bouts and each player may advance from a first rank to a higher rank based on mastery at each skill level;
advancing the rank of one or more of the players;
awarding a level ring to the player when the player meets one or more requirements of rank advancement, said level ring being displayable on the flexible sword-like device to indicate the player's advancement from the first rank to the higher rank

2. The method of claim 1 further comprising:
awarding a power ring to a player when the player meets one or more requirements of specific sword-like device fighting technical challenges or missions;
wherein said power rings represent respective powers that augment the abilities of the flexible sword-like device and are conferred to the player to be displayed on the flexible sword-like device.
